(19) United States
(12) Patent Application Publication
(10) Pub. No.: US 2003/0070049 A1
(43) Pub. Date: Apr. 10, 2003

(54) Memory control method, memory control circuit using the control method, and integrated circuit device with the memory control circuit

(75) Inventor: Kei Suzuki, Kokubunji (JP)

Correspondence Address: Stanley P. Fisher, Reed Smith LLP, 3110 Fairview Park Drive, Suite 1400, Falls Church, VA, 22042-4503, US

(73) Assignee: Hitachi, Ltd.

(21) Appl. No.: 10/261,483

(22) Filed: Oct. 2, 2002

(30) Foreign Application Priority Data
Oct. 4, 2001 (JP) P2001-308264

(51) Int. Cl. G06F 12/00; G06F 13/00

(52) U.S. Cl. 711/151; 711/100

(57) ABSTRACT

The present invention provides a memory control circuit in an LSI with a plurality of circuits performing a memory access which in the case of contention of memory accesses, can quickly complete the memory access having a severe time limit.

In the present invention, the memory control circuit handling a plurality of memory accesses can interrupt, into a memory access, another high-priority access request corresponding to memory access priority.

In the case of contention of memory accesses from the circuits, the memory access which must be completed within a fixed period can be processed precedably. It is possible to prevent deterioration of the operation quality of a system using an integrated circuit due to the unfollowed completion time limit of the memory access.

### BACKGROUND OF THE INVENTION

1. Field of the Invention

The present invention relates to a memory control method and a memory control circuit for use in a memory access in an integrated circuit system or a digital system incorporating a plurality of modules performing a memory access, and to an integrated circuit device with the memory control circuit.

2. Description of the Related Art

A dynamic RAM (DRAM) separately receives an address to be accessed as a row address or a column address and has a long access time for a different row address and has a short access time for reference to the same row address.

When a microprocessor refers to a program and a graphic processing circuit refers to video information, there is a process having a high rate in reference to successive address data. A memory device for high-speed access application of a synchronous DRAM has a burst transfer mode which can continuously access successive address data. In the burst transfer mode, time to access the first data at a memory access is the same as that of the prior art, and access to successive data can be performed in each cycle.

With the enhanced LSI integration, there are developed LSI with a plurality of circuit modules accessing data to a memory device on one LSI. These LSI typically share one or more memory devices by all the circuit modules performing a memory access on the LSI to limit the number of terminals of the LSI and reduce the parts cost of the entire system using the LSI. In other words, one memory control circuit is mounted on the LSI and the circuit modules performing a memory access on the LSI perform a memory access via the memory control circuit.

When sharing the memory device, the plurality of circuit modules on the LSI may attempt to perform a memory access to the memory device at the same time. In such a case, in a prior art, a memory control circuit is designed so that until one circuit module completes burst transfer, a memory access of the other circuit module waits.

### SUMMARY OF THE INVENTION

Voice and video information processes require a large calculation amount and must be completed within a fixed period. An LSI with a plurality of circuit modules or microprocessors performing such processes must complete these processes at the same time. A memory access to the memory device must be completed within a fixed period. In the prior art memory control circuit, however, until one access is completed, the other memory access waits, as described above. The memory access may not be completed within a required time.

To solve this, there is a method for increasing a data transfer frequency to the memory device. In this case, there are no memory devices operated at high frequencies or the cost of the memory device is high.

In the case of contention of memory accesses, the LSI with a plurality of circuits performing such memory access must quickly complete the memory access having a severe time limit.

An object of the present invention is to provide a memory control method which can complete a memory access having a severe time limit within a required time without needing any higher transfer frequency and any memory device operated at high frequencies.

Another object of the present invention is to provide a memory control circuit realizing the memory control method.

A further object of the present invention is to provide an integrated circuit device with the memory control circuit.

To solve the above problems, the memory control method according to the present invention can perform memory control, during a memory access, interrupting another high-priority memory access request according to memory access priority.

The memory control circuit according to the present invention can perform control, during a memory access, interrupting another high-priority memory access request according to memory access priority.

In particular, an SDRAM performs a pipeline operation. The memory control method of the present invention can interrupt a high-priority memory access. There has not been a memory control method in which the interruption interrupts the preceding memory access process is performed by stopping a clock input by clock enable, another priority interrupt memory access process is performed during that, and the preceding memory access process is re-executed successively.

Preferably, the memory control circuit has means for changing priority by the type of a memory access request and a request source. This can solve the above problems without depending on its use form.

The above objects and other objects of the present invention will be apparent by the following detailed description and the attached claims with reference to the accompanying drawings. In the accompanying drawings, like reference numerals denote the same or similar parts.

### BRIEF DESCRIPTION OF THE DRAWINGS

FIG. 1 is a diagram of assistance in explaining an example of a target system for explaining an embodiment of the present invention;

FIG. 2 is a diagram of assistance in explaining contention of a plurality of requests which is a problem of the present invention;

FIG. 3 is a diagram of assistance in explaining the case that an access completion time limit is not followed by the contention of a plurality of requests;

FIG. 4 is a diagram of assistance in explaining an operation following a process time limit by interrupting a process having a severe access completion time limit into the preceding request process by the present invention;

FIG. 5 is a diagram of assistance in explaining a method for connecting an LSI and memory devices in the embodiment of the present invention;

FIG. 6 is a diagram of assistance in explaining an operation of the same memory device, the same bank, the same ROW address, the preceding request being READ, and an interrupt request being READ;

FIG. 7 is a diagram of assistance in explaining an operation of the same memory device, the same bank, the same ROW address, the preceding request being READ, and an request being WRITE;

FIG. 8 is a diagram of assistance in explaining an operation of the same memory device, the same bank, the same ROW address, the preceding request being WRITE, and an interrupt request being READ;

FIG. 9 is a diagram of assistance in explaining an operation of the same memory device, the same bank, the same ROW address, the preceding request being WRITE, and an interrupt request being WRITE;

FIG. 10 is a diagram of assistance in explaining an operation of the same memory device, the same bank, a different ROW address, the preceding request being READ., and an interrupt request being READ;

FIG. 11 is a diagram of assistance in explaining an operation of the same memory device, a different bank, a different ROW address, the preceding request being READ, and an interrupt request being READ;

FIG. 12 is a diagram of assistance in explaining an operation of the same memory device, a different bank, a different ROW address, the preceding request being READ, and an interrupt request being WRITE;

FIG. 13 is a diagram of assistance in explaining an operation of the same memory device, a different bank, a different ROW address, the preceding request being WRITE, and an interrupt request being READ;

FIG. 14 is a diagram of assistance in explaining an operation of the same memory device, a different bank, a different ROW address, the preceding request being WRITE, and an interrupt request being WRITE;

FIG. 15 is a diagram of assistance in explaining an operation of a different memory device, the same bank, the same ROW address, the preceding request being READ, and an interrupt request being,READ;

FIG. 16 is a diagram of assistance in explaining an operation of a different memory device, the same bank, the same ROW address, the preceding request being READ, and an interrupt request being WRITE;

FIG. 17 is a diagram of assistance in explaining an operation of a different memory device, the same bank, the same ROW address, the preceding request being WRITE, and an interrupt request being READ;

FIG. 18 is a diagram of assistance in explaining an operation of a different memory device, the same bank, the same ROW address, the preceding request being WRITE, and an interrupt request being WRITE;

FIG. 19 is a diagram of assistance in explaining an operation of a different memory device, other than FIG. 15, the preceding request being READ, and an interrupt request being READ;

FIG. 20 is a diagram of assistance in explaining an operation of a different memory device, other than FIG. 16, the preceding request being READ, and an interrupt request being WRITE;

FIG. 21 is a diagram of assistance in explaining an operation of a different memory device, other than FIG. 17, the preceding request being WRITE, and an interrupt request being READ,

FIG. 22 is a diagram of assistance in explaining an operation of a different memory device, other than FIG. 18, the preceding request being WRITE, and an interrupt request being WRITE;

FIG. 23 is a diagram showing an example of a target system of the present invention;

FIG. 24 is a diagram of assistance in explaining a memory device having a clock enable terminal and a data mask terminal for each bank;

FIG. 25 is a diagram of assistance in explaining a memory device having a register setting a burst length for each bank;

FIG. 26 is a diagram of assistance in explaining an operation of a different memory device, the same bank, the same ROW address, the preceding request being READ, and an interrupt request being READ using a memory device allowing an output to be in a high impedance state when asserting a data mask during a memory access to negate clock enable;

FIG. 27 is a diagram of assistance in explaining a memory control circuit having a register setting priority for each processor;

FIG. 28 is a diagram of assistance in explaining a memory control circuit having a plurality of registers setting priority for each processor;

FIG. 29 is a diagram of assistance in explaining a memory control circuit having a plurality of registers setting priority for each processor which decides the priority setting register to be referred by a timer; and

FIG. 30 is a diagram of assistance in explaining an example switching a plurality of priority decision methods by a value of a priority setting method selection register in the memory control circuit having a plurality of registers setting priority for each processor.

### DETAILED DESCRIPTION OF THE PREFERRED EMBODIMENTS

Preferred embodiments of the present invention will be described below with reference to the accompanying drawings. In the following description, the reference numerals of signal lines serve as a signal name, a command name, and a signal terminal name.

<Embodiment 1>

FIG. 23 shows a system configuration example applying the present invention.

FIG. 23 shows a system configured by a semiconductor integrated circuit device (hereinafter called an LSI) 10 having a memory interface 11, a video interface 12, a USB (universal serial bus) interface 13 and a switch port 14, and memory devices 15, 16. The system of the drawing incorporates, in the LSI 10, a video signal generation circuit 20, a graphic processing circuit 21, a DMA (direct memory access) control circuit 22, a USB interface circuit 23, a microprocessor 24, a digital signal processor 25, and a memory control circuit 26.

The graphic processing circuit 21 processes video information based on command information stored into the memory devices 15, 16. The video signal generation circuit 20 converts the video information to a video signal. The DMA control circuit 22 writes data received by the USB interface circuit 23 via the USB interface 13 into the memory devices 15, 16. The received data includes encoded graphic information and voice information.

The microprocessor 24 performs two time division processes. One of the processes is a process controlling the entire system and performs initial setting of the DMA control circuit 22 and the graphic processing circuit 21 by a signal value of the switch port 14 to start the process or stop the system.

The other process is a process performed by extracting graphic information and voice information from the data transferred from the USB interface 13 onto the memory devices 15, 16. In other words, the graphic information is converted to command information to the graphic processing circuit 21 to be stored onto the memory devices 15, 16. The voice information is re-arranged onto the memory devices 15, 16.

The digital signal processor 25 processes the voice information on the memory devices 15, 16 to decode the voice information. The decoded voice information is sent to the video signal generation circuit 20 to be superimposed on a video signal.

In the system, the graphic processing performs a process for 30 screens for a second. A process for one screen must be completed within 1/30 sec. The DMA control circuit 22 stores data of 500 k bytes to 1M byte into the memory devices 15, 16 for one second. The microprocessor 24 must process the command information to the graphic processing circuit 21 30 times for a second and the voice information to the digital signal processor 25 1200 times for a second. The digital signal processor processes the data encoded 1200 times for a second to finally decode the voice information having a bandwidth of 48 kHz.

Unless these processes are completed within a fixed time, the graphic processing is not smoothed so that a video screen is disturbed and the voice decode processing is not smoothed so that voice is interrupted, resulting in lowered operation quality of the system. The process is performed to the information stored into the one memory device 15 or 16. The memory devices 15, 16 must have a sufficient data transfer speed. In addition, the data transfer amount is varied with time. The memory devices 15, 16 must have a data transfer speed enough to handle a data transfer amount at peak. Use of expensive memory devices having a high data transfer speed due to peak occurrence which is very rare is not economical. Depending on the system specifications, the performance at peak may exceed the data transfer speed of the available memory devices.

The memory control circuit of the present invention has no data transfer speed enough to handle a data transfer amount at peak, but can perform memory control for realizing a system executing the above process using memory devices having an averagely sufficient data transfer speed.

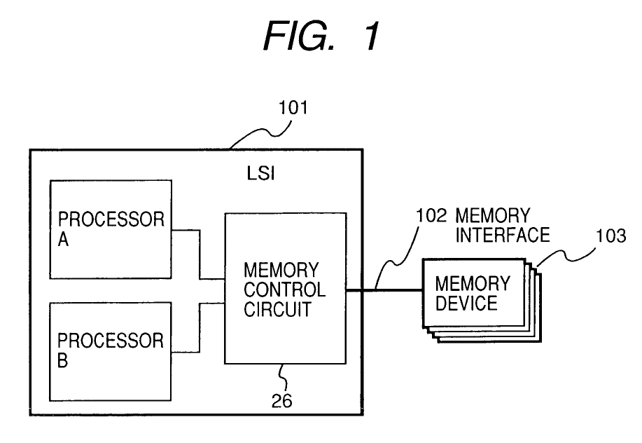

Here, for description, there is considered a configuration in which an LSI 101 incorporating two processors A, B and the memory control circuit 26 shown in FIG. 1 is connected to the memory device via a memory interface 102. Here, the processor refers to all circuits mounted on the LSI accessing a memory device 103 such as the graphic control circuit 20, the DMA control circuit 22, the microprocessor 24 or the digital signal processor 25 in FIG. 23.

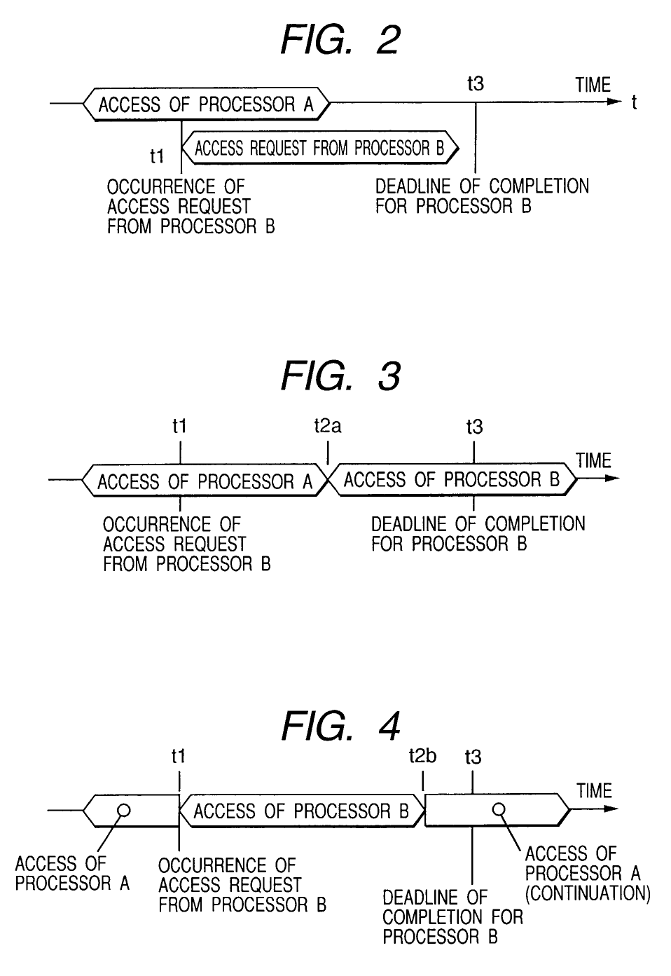

As explanation of the embodiment, there is considered the case that an access request to the memory device 103 of the processor B occurs at time t1 during which the processor A accessing the memory device 103, as shown in FIG. 2. Time t3 is a time of an access completion time limit of the processor B.

A memory device having a high data transfer speed such as a synchronous DRAM has a long time from giving an access request to referring to the first data. For this reason, the so-called burst access sequentially accessing data from a specified address to efficiently access data is performed. It takes time to some extent for the access process. As shown in FIG. 3, in the prior art, after time t2a completing the access process of the processor A, the access process of the processor B is performed. The processor B cannot complete the access within the time t3 as the access completion time limit. The processor B cannot hold the operation quality of the system to specifications.

The memory control circuit of the present invention performs control such that when an access request of the processor B occurs at the time t1 as shown in FIG. 4, the access process of the processor A is interrupted at this point to perform the access process of the processor B, and then, the access process of the processor A is restarted at time t2b after completion thereof. The access process of the processor B is completed within the time t3.

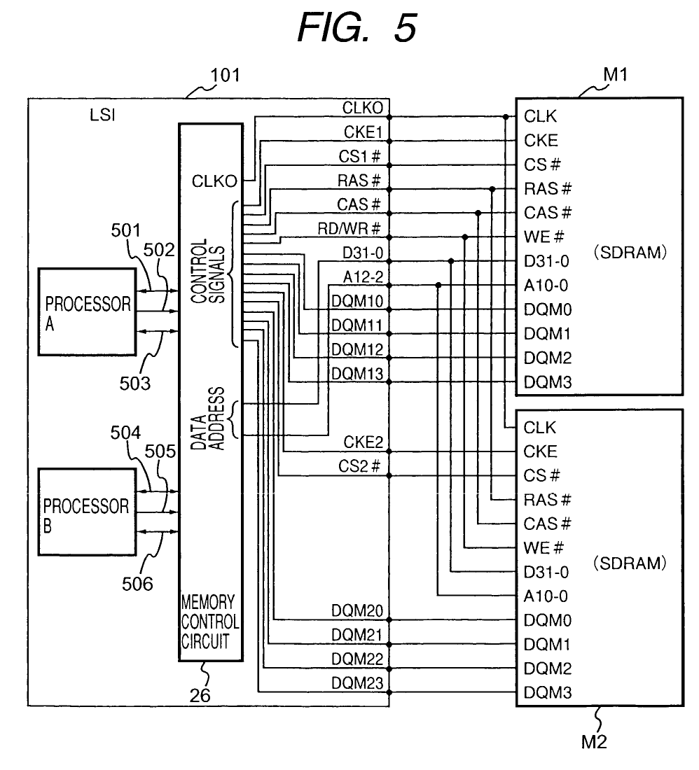

Using FIGS. 5 to 22, the detailed operations of the embodiment of the present invention will be described below.

FIG. 5 is a diagram showing a connection example of the LSI 101 incorporating the memory control circuit 26 and two memory devices. The memory control circuit 26 and the processors A and B are mounted on the LSI 101. The processor A is connected to the memory control circuit 26 by a control signal line 501, an address signal line 502, and a data signal line 503. Likewise, the processor B is connected thereto by a control signal line 504, an address signal line 505, and a data signal line 506.

A synchronous DRAM (SDRAM) is taken as an example in the drawing for memory devices M1, M2. The same control is possible in a normal DRAM, an EDO (Extended Data Out) DRAM, and a double data rate (DDR) SDRAM. Other than the DRAM device, other memory devices and LSI devices having the same interface as DRAM and SDRAM may be used.

The LSI 101 and the memory devices M1, M2 are connected by clock signal lines (CLKO on the LSI side and CLK on the memory device side), clock enable signals (CKE1, CKE2 on the LSI side and CKE on the memory device side), chip select signals (CS1# and CS2# on the LSI side and CS# on the memory device side), an RAS (row address strobe) signal line RAS#, a CAS (column address strobe) signal line CAS#, a write signal line WE#, data signal lines D0 to D31, address signal lines (A12 to 2 on the LSI side and A10 to A0 on the memory device side) , and data control signals (DQM10, DQM11, DQM12, DQM13, DQM20, DQM21, DQM22 and DQM23 on the LSI side and DQM0, DQM1, DQM2 and DQM3 on the memory device side) . The data control signal DQM is also called a data mask signal in the synchronous DRAM.

In the example of FIG. 5, two memory devices are connected. One or three or more memory devices can be connected. When connecting three or more memory devices, the clock signal, the RAS signal, the CAS signal, the write signal, the data signal and the address signal are common in all the memory devices. Other signals are provided with a dedicated signal line for each of the memory devices.

The operation can be classified into 24 types. There are the following five classification items from the relation of the request (access request) of the processor A and the request (access request) of the processor B.

[1] Are two requests are accessed to the same memory device or a different memory device?

[2] Is a memory device accessed to the same bank as the immediately preceding request?

[3] Is a memory device accessed to the same row (ROW) address as the immediately preceding request?

[4] Is the preceding request is read (READ command) or write (WRITE command)?

[5] Is an interrupt request is read (READ command) or write (WRITE command)?

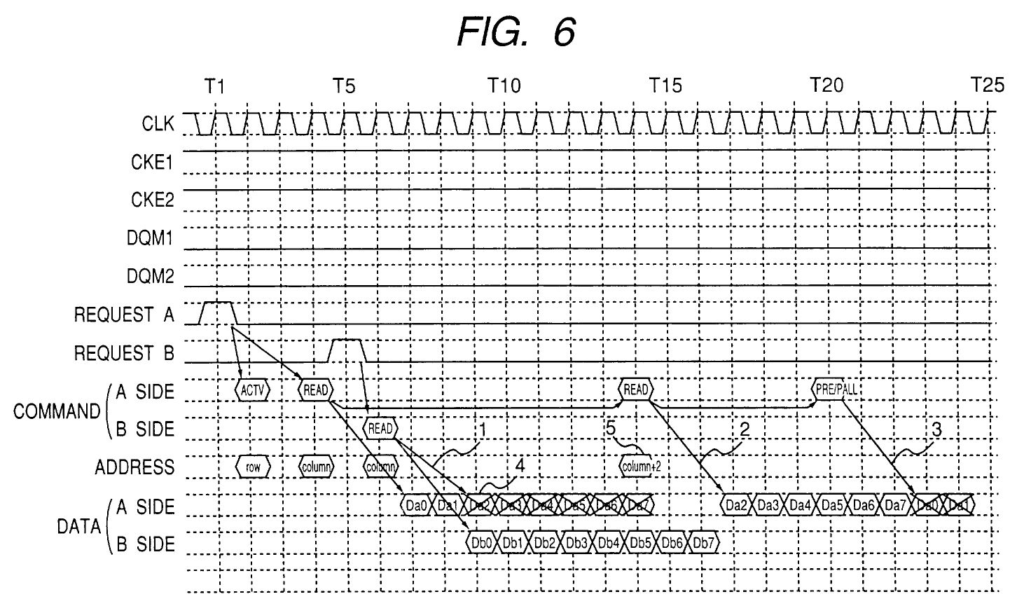

FIGS. 6 to 22 are diagrams of assistance in explaining an operation of a combination thereof, respectively.

In the examples of FIGS. 6 to 22, time differences between the preceding request A and an interrupt request B are all equal. In the memory device setting, a CAS latency is 3 cycles and a burst length is 8. In other cases, the same process is performed.

When setting a different burst length for each of the memory devices, the same process is performed. FIG. 6 is a diagram of assistance in explaining an operation of the same memory device, the same bank, the same row address, the preceding request being a read (READ) command, and an interrupt request being a READ command. By way of example, the case of the same memory device will be described below as an access to the memory device M1. The request process on the processor B side is a process which must be completed in 16 clock cycles after occurrence of the request on the B side.

Referring to FIG. 6, a control operation will be described below based on the clock signal CLK on the memory side. The clock enable signals CKE1, CKE2 on the LSI 101 side are at the High level. That is, the clocks are inputted from the memory control circuit side to the memory devices M1, M2 so that the memory devices are in an operation state. The data control signals DQM1, DQM2 on the memory devices M1, M2 sides are at the Low level. That is, data can be inputted and outputted.

The memory control circuit 26 performs the control operation as follows.

Upon reception of a READ request signal (request A) from the processor A, it is transferred to the memory device M1 at the rising edge of cycle T1 of the clock signal CLK (similarly, operated to be synchronized with the rising edge of the clock signal below). In cycle T2, based on the request signal of the processor A, an active (ACTV) command corresponding to the READ request from the processor A is transferred to the memory device M1 and a row address is transferred to the memory device M1.

In cycle T4, a read (READ) command on the processor A side is transferred to the memory device M1 and a column address is transferred to the memory device M1.

In cycle T5, an interrupt request from the processor B occurs, and then, a READ request signal (request B) is transferred to the memory device M1. In the next cycle T6, based on the request signal, a READ command of the processor B is transferred to the memory device M1. At the same time, in the cycle T6, the next column address is transferred to the memory device M1 for the process by the preceding request A.

In cycles T7, T8, data Da0, Da1 stored into the row and column addresses of the memory device M1 specified by the request A are read successively to the processor A side.

In cycle T9, as indicated by the reference numeral 1 in the drawing, the READ command for the process of the request B transferred in the cycle T6 performs an operation canceling or inhibiting a sequential data read process after Da2 of the request A (hereinafter called merely “cancel operation”). There are the following four types of the cancel operation 1.

(1-1) The preceding operation is stopped by giving the read command READ (or the write command WRITE) for the process of the request B.

(1-2) The preceding operation is stopped by giving a precharge command PRE/PALL.

(1- 3) The data mask signal DQM is asserted to idle read or idle write data.

Asserting the DQM means that the DQM signal is masked, that is, at the High level. In the embodiment, both or either of DQM1 and DQM2 as the DQM signal of the LSI 101 is at the High level.

(1-4) The clock enable signal CKE is asserted to stop the operation of the memory device performing the process of the request A.

Asserting the CKE means that the CKE signal is disabled, that is, at the Low level. In the embodiment, both or either of CKE1 and CKE2 as the CKE signal of the LSI 101 is at the Low level.

The cancel operation 1 of FIG. 6 is an example of the (1-1). This cancels sequential transfer of remaining read data Da2 to Da7 by the request A after the cycle T9, as indicated by the reference numeral 4. The data Da0 to Da7 of the memory device of the read row and column addresses specified by the request B are synchronized with the cycles T9 to T16 to be sequentially transferred to the processor B side.

In the cycle T14, an address update operation indicated by the reference numeral 5 is performed to re-execute the request A. While the READ command on the processor A side is transferred to the memory device M1, an updated column address (column+2) specifying the next row of the data Da1 processed before cancel is transferred. The value of 2 is a value varied depending on where the interrupt request B occurs.

To give the updated column address, when performing the cancel operation 1, the memory control circuit may be controlled so as to count the number of data read for cancel and transfer an address adding the count value to the first specified column address (column). There may be provided a counter counting the number of data transferred for cancel, a register memorizing a column address transferred before that, and an adder adding the count value and the column address value.

In the cycle T17 after the read process by the interrupt of the request B is completed, a re-execution operation is performed, as indicated by the reference numeral 2. The read operation by the request A is re-executed from the data Da2 specified by the updated column address. There are the following two control methods of the re-execution operation 2.

(2-1) The read command READ (or the write command WRITE) is given again.

(2-2) The clock enable CKE is deasserted.

Deasserting the CKE means that the CKE signal is enabled, that is, at the High level. In the embodiment, both or either of CKE1 and CKE2 as the CKE signal of the LSI 101 is at the High level.

When performing the re-execution operation by the (2-1) control method, an address to be given must be updated so as to specify the nest data of the data processed before cancel.

The re-execution operation 2 of FIG. 6 is an example of the (2-1).

In cycle T20 reading the data Da5 within the period processing the sequential read operation of the burst length of 8 from the memory M1 to the processor A side by the request A, in order to perform an operation re-canceling or re-inhibiting the request A (hereinafter called merely “re-cancel operation”) , the precharge command (PRE/PALL) on the processor A side is transferred to the memory M1. The CAS latency is three cycles. This completes the sequential read operation of the unnecessary data Da0, Da1 from the memory device M1 to the processor A side after cycle T23. There are the following two types of the re-cancel operation 3.

(3-1) The precharge command PRE/PALL is given to stop the operation.

(3-2) The data mask DQM is asserted to idle read or idle write data.

The re-cancel operation 3 of FIG. 6 is an example of the (3-1).

As described above, memory control is performed so that the process by the READ request B from the processor B is interrupted precedably, and then, the access of the processor B is executed in 11 cycles after occurrence of the request to continue the process by the request from the processor A.

Such control operation of the memory control circuit 26 can complete the process of the READ request B from the processor B within a completion time limit (16 cycles after occurrence of the request B) . In the control of FIG. 2 of the prior art, the READ request B is processed after completing the process of the READ request A. Reading of the READ request B is started from the cycle T15. In the cycle T22, the process of the request B is completed. The process of the READ request B requires 17 cycles after the request on the processor B side occurs in the cycle T5. The completion time limit of the request B cannot be satisfied.

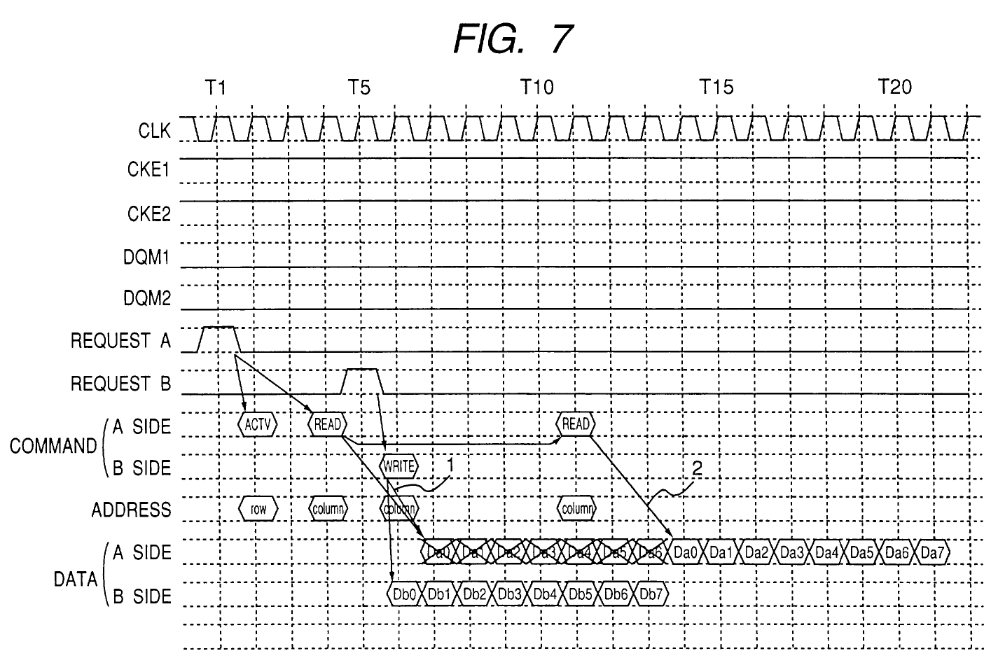

The processes shown in FIGS. 7 to 22 including FIG. 6 have a combination of three common operations.

A first operation cancels or inhibits the operation of the preceding request A. That is, it is the cancel operation 1 in the process operation of FIG. 6.

A second operation re-executes or restarts the operation of the cancelled or inhibited request A. That is, it is the re-execution operation 2 in the process operation of FIG. 6.

A third operation cancels or inhibits again the re-executed request A. That is, it is the re-cancel operation 3 in the process operation of FIG. 6.

FIG. 7 is a diagram of assistance in explaining an operation of the same memory device, the same bank, the same ROW address, the preceding request A being a READ command and an interrupt command being a WRITE command. It is different from FIG. 6 in the operation after the cycle T5. For the control operation of the memory control circuit 26, the operation after the cycle T5 of the clock signal CLK will be described below.

Upon reception of a request B from the processor B in the cycle T5, the WRITE request B corresponding to the request is transferred to the memory device M1. In the next cycle T6, based on the WRITE request signal, the WRITE command on the processor B side is transferred to the memory device M1 and data Db0 written from the processor B is transferred to the memory device M1.

In the cycles T7 to T13, while the sequential data read operation by the preceding request A is canceled by the cancel operation 1 by the WRITE command corresponding to the request B of the processor B side in the cycle T6, write data Db1 to Db7 on the processor B side are transferred to the memory device M1 to be synchronized with the clock. The cancel operation 1 is (1-1) of the above four types.

In the cycle T11 transferring the write data Db5 on the processor B side, the re-execution operation 2 is performed to restart the process of the request A in the next cycle T14 of the cycle T13 completing the process of the request B. In other words, the READ command corresponding to the request A on the processor A side is re-issued and at the same time, the column address (column) of the data Da0 staring read is transferred to the memory device M1. The re-execution operation 2 is (2-1) of the above two control methods.

In the cycle T14, the READ command corresponding to the request A starts the re-execution operation 2. In the cycles T14 to T21, the read data Da0 to Da7 synchronized with the clock CLK are sequentially transferred from the memory device M1 to the processor A side. The burst length of 8 is read by the READ request A. The re-cancel operation 3 as shown in FIG. 6 is unnecessary.

A control operation of the memory control circuit 26 is performed to be completed in 8 cycles after occurrence of the WRITE request B. The completion time limit of the request B can be satisfied. When performing the process of the request B after completing the burst read of the preceding request A as in the prior art, the completion time limit of the request B cannot be satisfied in 17 cycles.

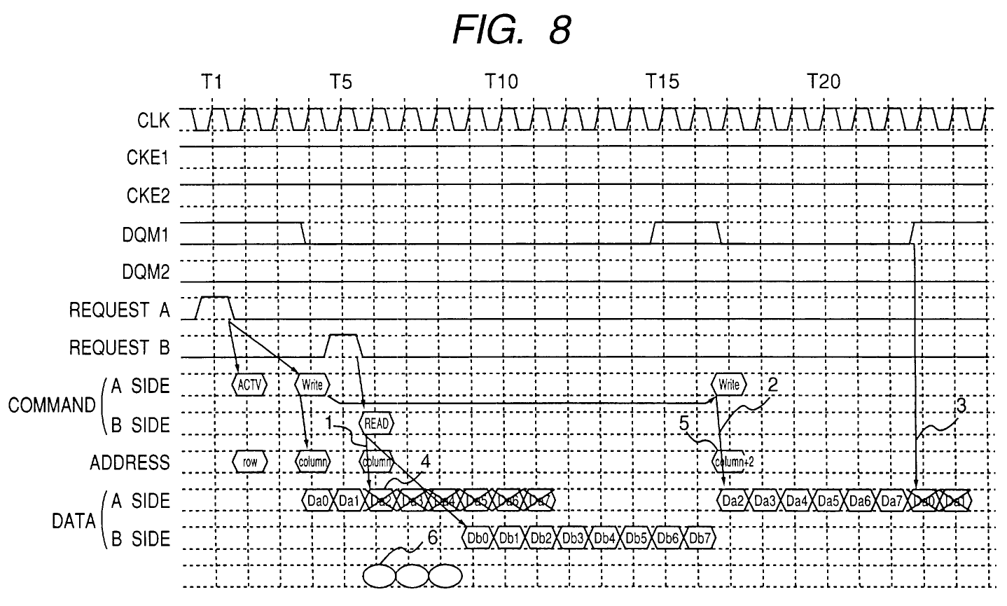

FIG. 8 is a diagram of assistance in explaining an operation of the same memory device, the same bank, the same ROW address, the preceding request being a WRITE command, and an interrupt request being a READ command.

In FIG. 8, unlike the above operations, the state of the data control signal DQM1 is varied. The data control signal DQM1 of the memory device M1 is at the High level to the cycle T3, in the T15 and T16, and after the T23. In the READ command operation, the data output terminal is of high impedance after two clock cycles irrespective of the CAS latency so that data is stopped (in a state that no data are read from the memory device). In the WRITE command operation, the data at the High level of the corresponding clock is not written into the memory device.

In the periods of the cycles T4 to T14 and T17 to T22, the data control signal DQM1 is at the Low level and data can be inputted and outputted.

The memory control circuit 26 receives the WRITE request signal (request A) from the processor A to transfer the request A to the memory device M1 in the cycle T1. In the cycle T2, it transfers an active (ACTV) command and the row address corresponding to the WRITE request from the processor A to the memory device M1.

In the cycle T4, the WRITE command on the processor A side and the column address are transferred to the memory device M1 and transfer of the write data Da0 is started to be synchronized with the clock.

In the cycle T5, the interrupt READ request B from the processor B occurs to be transferred to the memory device M1. The data Da1 performing the write process of the preceding processor A side is also transferred to the memory device M1.

In the cycle T6, the READ command for the process of the READ request B transferred in the cycle T5 performs the cancel operation 1 canceling transfer for the sequential data write process after the write data Da2 of the preceding processor A. At the same time, the column address of data start for the read process of the READ request B is transferred to the memory device M1. The cancel operation 1 is (1-1) of the above four control methods.

The CAS latency is 3. In the cycle T9, the burst read of the READ request B is started. The data Db0 to Db7 synchronized with the period clock to the cycle T16 are sequentially read to the processor B side.

To sequentially execute the write process of the processor A, the WRITE command on the processor A side and the updated column address (column+2) are transferred to the memory device M1 in the cycle T17 to execute the re-execution operation 2 of burst write from the data Da2. The re-execution operation 2 is (2-1) of the above two control methods.

In the cycle T23, to re-cancel transfer of the write data Da0, Da1 from the processor A, the data control signal DQM1 is at the High level to execute the re-cancel operation 3. The re-cancel operation 3 is (3-2) of the above two control methods.

A control operation of the memory control circuit 26 is performed to be completed in 11 cycles after occurrence of the READ request B. The completion time limit of the request B can be satisfied. When performing the READ process of the request B after completing the WRITE process of the request A as in the prior art, the completion time limit of the request B can be satisfied in 14 cycles, which is slower than the control method of the present invention.

In the control method of FIG. 8, the interrupt process from the processor B increases the total process time. As indicated by the reference numeral 6, in the clock cycles T6 to T8, wasteful cycles not inputting and outputting data occur. When unpreferably such wasteful cycles occur to increase the process time, a control register value in the memory control circuit may make the switch not to execute the control method of FIG. 8.

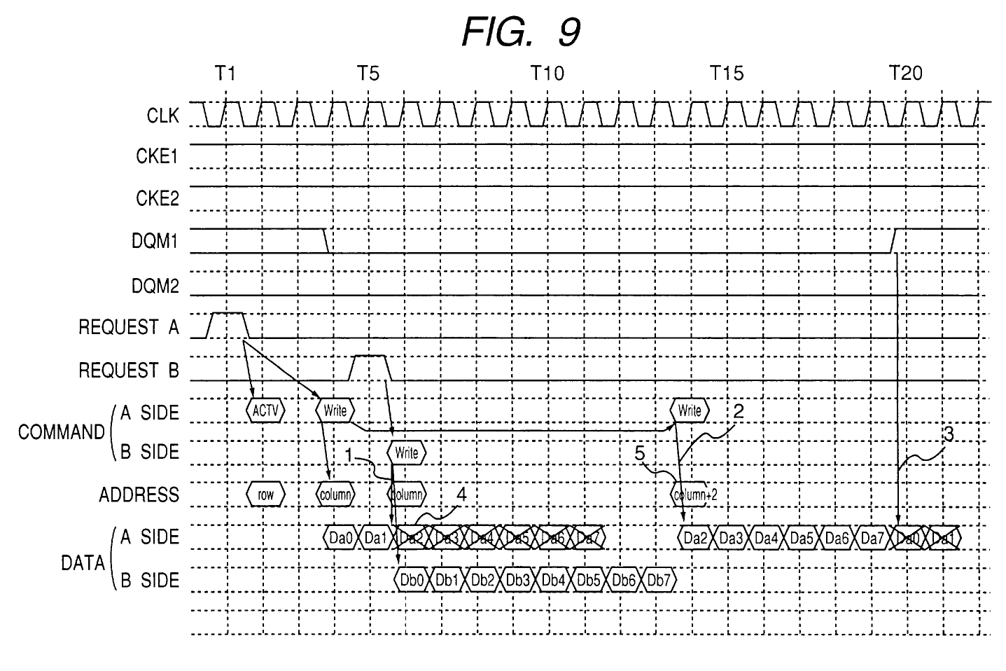

FIG. 9 is a diagram of assistance in explaining an operation of the same memory device, the same bank, the same ROW address, the preceding request being WRITE, and an interrupt request being WRITE.

In FIG. 9, in the periods of the cycles T4 to T19, the data control signal DQM1 is at the Low level and data can be inputted and outputted.

The operation to the clock cycle T4 is the same as FIG. 8. In the cycle T5, the interrupt WRITE request B from the processor B occurs to be transferred to the memory device M1 and the data Da1 performing the write process of the preceding processor A side is also transferred to the memory device M1.

In the cycle T6, the WRITE command for the process of the WRITE request B transferred in the cycle T5 performs the cancel operation 1 canceling the sequential data write process after the write data Da2 of the preceding processor A. The cancel operation 1 is (1-1) of the above four control methods. At the same time, the column address of data start for the write process of the WRITE request B and the start data Db0 of burst write are transferred to the memory 1. The write data Db1 to Db7 synchronized with the clock CLK are transferred to the memory device M1 to the cycle T13.

To sequentially execute the write process of the processor A, the WRITE command on the processor A side and the updated column address (column+2) are transferred to the memory device M1 in the cycle T14 to execute the re-execution operation 2 of the burst write from the data Da2. The re-execution operation 2 is (2-1) of the above two control methods.

In the cycle T20, to re-cancel transfer of the write data Da0, Da1 from the processor A, the data control signal DQM1 is at the High level to execute the re-cancel operation 3. The re-cancel operation 3 is (3-2) of the above two control methods.

A control operation of the memory control circuit 26 is performed to be completed in 8 cycles after occurrence of the WRITE request B. The completion time limit of the request B can be satisfied. The control operation is completed in 14 cycles in the prior art method.

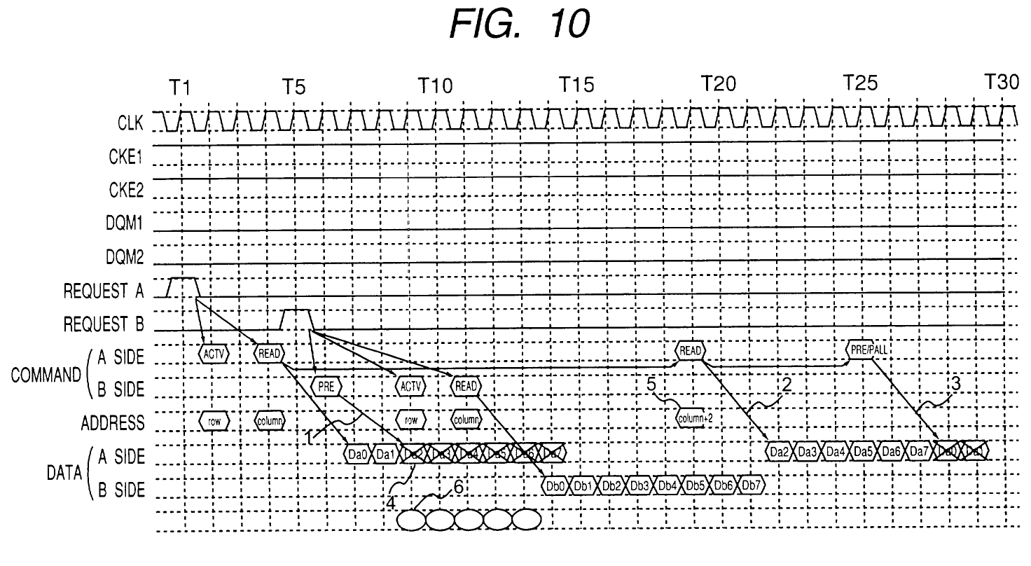

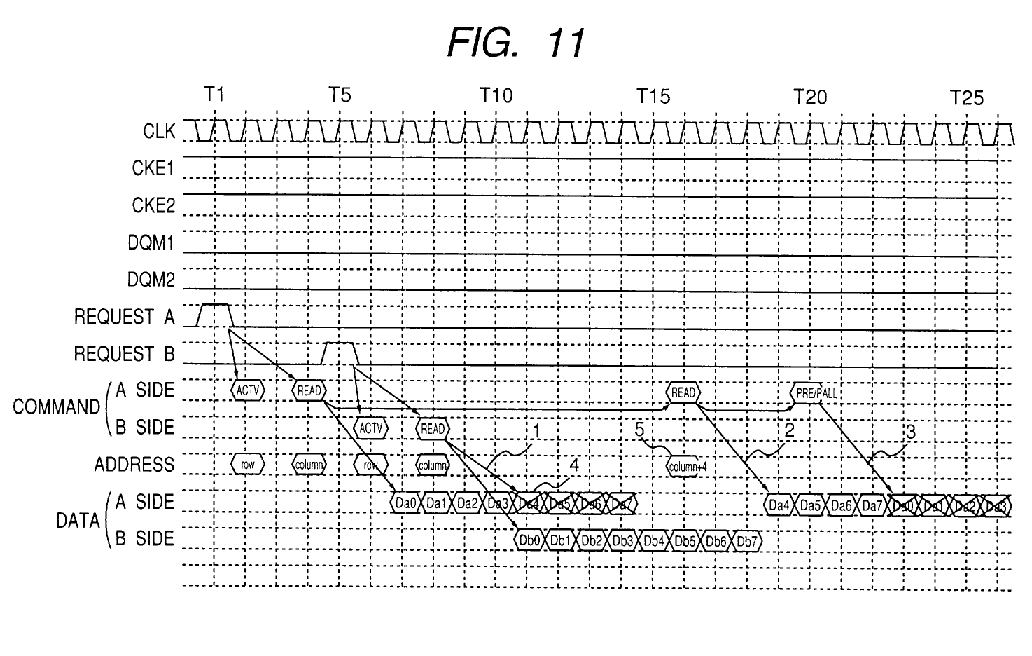

FIG. 10 is a diagram of assistance in explaining an operation of the same memory device, the same bank, a different ROW address, the preceding request being READ, and an interrupt request being READ.

In FIG. 10, as in FIG. 6, the clock enable signals CKE1 CKE2 on the LSI 101 side are at the High level and the data control signals DQM1, DQM2 on the memory device side are at the Low level.

The operation of the memory control circuit 26 to the clock cycle T5 is the same as FIG. 6.

An interrupt request accessing a different row address from the processor B occurs in the cycle T5 to transfer the READ request signal (request B) to the memory device M1 and the request signal transfers the precharge command PRE on the processor B side to the memory device M1 in the next cycle T6.

In the cycles T7, T8, the READ command on the processor A side reads the data Da0, Da1 synchronized with the clock from the memory device M1 to the processor A side.

In the cycle T9, the active (ACTV) command and the row address corresponding to the READ request from the processor B are transferred to memory device M1. At the same time, the precharge command PRE on the processor B side transferred in the cycle T6 executes the cancel operation 1 canceling read after the data Da2 by the preceding request A. The cancel operation 1 is (1-2) of the above four control methods.

In the cycle T11, the READ command on the processor B side and the start column address (column) of the burst read are transferred to the memory device M1. From the cycle T14, data from the data Db0 stored into the specified row and column addresses of the memory device M1 to the processor B side are read sequentially to be synchronized with the clock. The reading is completed in the cycle T21.

In the cycle T19 executing the process of the READ request B, to restart the process of the READ request A, the READ command on the processor A side and the updated column address (column+2) are transferred to the memory device M1. In the next cycle T22 completing the process of the request B, the read process of the request A from the Da2 is started. In other words, the re-execution operation 2 is performed. The re-execution operation 2 is (2-1) of the above two control methods.

In the cycle T25, the precharge command (PRE/PALL) on the A side is transferred to the memory device to perform the re-cancel operation 3 for canceling transfer of the data Da0, Da1 after the cycle T28. The re-cancel operation 3 is (3-1) of the above two control methods.

A control operation of the memory control circuit 26 is performed to be completed in 16 cycles after occurrence of the READ request. The completion time limit of the request B can be satisfied. In the prior art control method, the completion time limit of the request B cannot be satisfied in 17 cycles.

Also in the control method of FIG. 10, the wasteful cycles 6 occur in the cycles T9 to T13 as in FIG. 8. When unpreferably the wasteful cycles occur to increase the process time, the control register value in the memory control circuit may make the switch not to execute the control method of FIG. 10.

FIG. 11 is a diagram of assistance in explaining an operation of the same memory device, a different bank, a different ROW address, the preceding request being READ, and an interrupt request being READ.

In FIG. 11, as in FIG. 10, the clock enable signals CKE1, CKE2 on the LSI 101 side are at the High level and the data control signals DQM1, DQM2 on the memory device side are at the Low level.

The operation of the memory control circuit 26 to the clock cycle T5 is the same as FIG. 10.

An interrupt request accessing a different row address of a different bank from the processor B occurs in the cycle T5 to transfer the READ request signal (request B) to the memory device M1.

In the next cycle T6, the active (ACTV) command is transferred to the memory device 1 corresponding to the READ request from the processor B and the row address is transferred to the memory device M1.

In the cycle T7, transfer of the data Da0 stored into the row and column addresses specified from the memory device 1 by the READ request A to the A side is started.

In the cycle T8, the READ command on the processor B side and the column address corresponding to the READ request are transferred to the memory device M1. At the same time, the next read data Da1 is transferred to the processor A side.

In the cycles T9, T10, the read data Da2, Da3 are transferred to the processor A side.

In the cycle 11, the later read process to the processor A side is canceled by the READ command on the B side transferred in the cycle T8 (the cancel operation 1) to start the burst read process of the data Db0 to Db7 by the READ request B. The cancel operation 1 is an example of (1-1) of the above four control methods.

In the cycle T16 of a period performing the read process by the READ request B, to restart the process of the READ request A, the READ command on the processor A side and the updated column address (column+4) are transferred to the memory device M1. In the next cycle T19 completing the process of the request B, the read process of the request A from the Da4 is started. In other words, the re-execution operation 2 is performed. The re-execution operation 2 is (2-1) of the above two control methods.

In the cycle T20, the precharge command (PRE/PALL) on the A side is transferred to the memory device to perform the re-cancel operation 3 for canceling transfer of the data Da0 to Da3 after the cycle T23. The re-cancel operation 3 is (3-1) of the above two control methods.

A control operation of the memory control circuit 26 is performed to be completed in 13 cycles after occurrence of the interrupt READ request. The completion time limit of the request B can be satisfied. In the prior art control method, the completion time limit of the request B cannot be satisfied in 17 cycles.

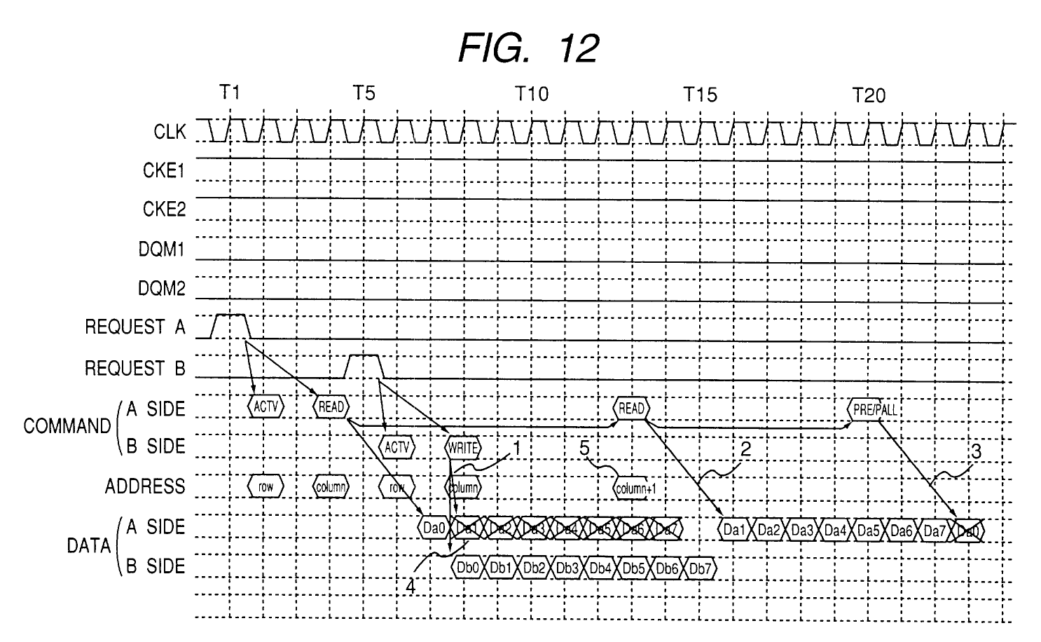

FIG. 12 is a diagram of assistance in explaining an operation of the same memory device, a different bank, a different ROW address, the preceding request being READ, and an interrupt request being WRITE.

FIG. 12 is different from the example of FIG. 7 in the operation after the cycle T5. For the control operation of the memory control circuit 26, the operation from the cycle T5 of the clock signal CLK will be described.

Upon reception of the WRITE request B from the processor B in the cycle T5, in the cycle T6, the active (ACTV) command corresponding to the WRITE request and a row address different from the processor A are transferred to the memory device M1.

In the cycle T7, the READ command by the request A starts transferring the read data Da0 to the A side. The WRITE command corresponding to the WRITE request B in the next cycle T8 cancels transfer after the read data Da1 to the A side (the cancel operation 1). The cancel operation 1 is (1-1) of the above four control methods. At the same time, in the cycle T8, the column address written by the request B and the first data Db0 of the burst write are transferred to the memory device M1.

The write process by the WRITE command on the B side is performed to be synchronized with the clock to the cycle T15. In the cycle T13, to restart the process of the READ request A, the READ command on the processor A side and the updated column address (column+1) are transferred to the memory device M1. In the next cycle T16 completing the process of the request B, the read process of the request A from the Da1 is started. In other words, the re-execution operation 2 is performed. The re-execution operation 2 is (2-1) of the above two control methods

In the cycle T20, the precharge command (PRE/PALL) on the A side is transferred to the memory device to perform the re-cancel operation 3 for canceling transfer of the data Da0 in the cycle T23. The re-cancel operation 3 is (3-1) of the above two control methods.

A control operation of the memory control circuit 26 is performed to be completed in 10 cycles after occurrence of the interrupt WRITE request B. The completion time limit of the request B can be satisfied. In the prior art control method, the completion time limit of the request B cannot be satisfied in 17 cycles.

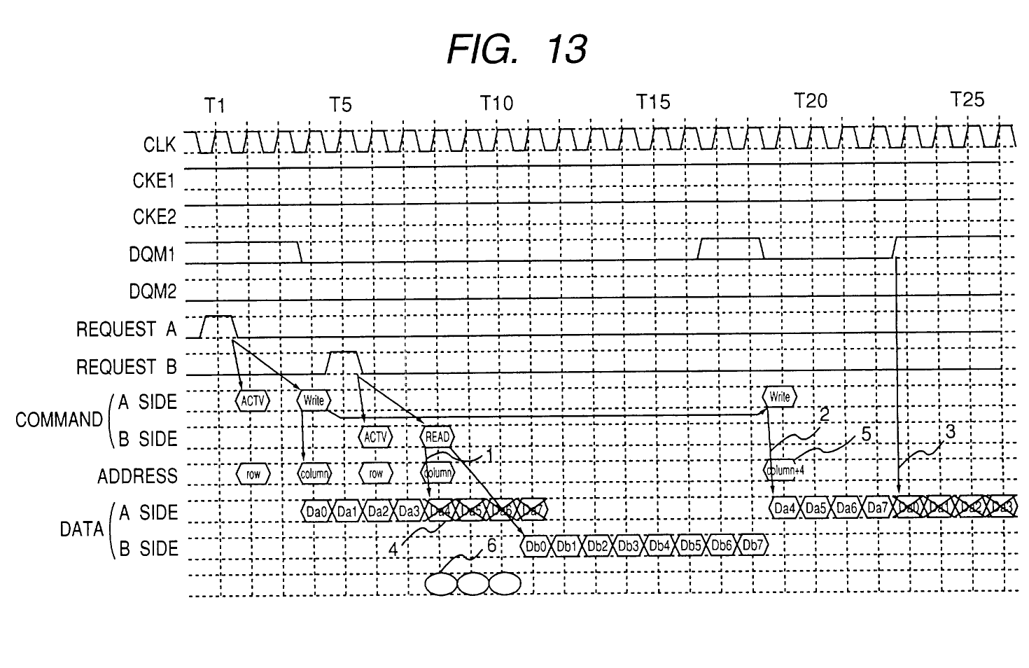

FIG. 13 is a diagram of assistance in explaining an operation of the same memory device, a different bank, a different ROW address, the preceding request being WRITE, and an interrupt request being READ.

The data control signal DQM1 of the memory device M1 is at the High level to the cycle T3, in the T17 to T18, and after the T23. In the READ command operation, the data output terminal is of high impedance after two clock cycles irrespective of the CAS latency and data is stopped (in a state that no data are read from the memory device). In the WRITE command operation, the data at the High level of the corresponding clock is not written into the memory device.

In the periods of the cycles T4 to T16 and T19 to T22, the data control signal DQM1 is at the Low level and data can be inputted and outputted.

The same operation as FIG. 8 is performed to the cycle T4 In the cycle T5, the interrupt READ request B from the processor B occurs to be transferred to the memory device M1. The data Da1 performing the write process of the preceding processor A side is also transferred to the memory device M1.

In the cycle T6, the active (ACTV) command and the row address corresponding to the READ request from the processor B in the cycle T5 are transferred to the memory device M1. The data Da2 performing the write process of the preceding processor A side is also transferred to the memory device M1.

In the cycle T8, the READ command for the process of the request B performs the cancel operation 1 canceling transfer to the memory device 1 after the write data Da4 of the preceding processor A. At the same time, the column address of data start for the read process of the READ request B is transferred to the memory device 1. The cancel operation 1 is (1-1) of the above four control methods.

In the cycle T11, the burst read of the READ request B is started. The data Db0 to Db7 synchronized with the period clock to the cycle T18 are read to the processor B side.

To sequentially execute the write process of the processor A, the WRITE command on the processor A side and the updated column address (column+4) are transferred to the memory device M1 in the cycle T19. The re-execution operation 2 for the burst write from the Da4 is performed. The re-execution operation 2 is (2-1) of the above two control methods.

In the cycle T23, to re-cancel transfer of the write data Da0 to Da3 from the processor A, the data control signal DQM is at the High level to execute the re-cancel operation 3. The re-cancel operation 3 is (3-2) of the above two control methods.

A control operation of the memory control circuit 26 is performed to be completed in 13 cycles after occurrence of the READ request B. The completion time limit of the request B can be satisfied. When performing the READ process of the request B after completing the WRITE process of the request A as in the prior art, the completion time limit of the request B can be satisfied in 14 cycles, which is slower than the control method of the present invention.

In the control method of FIG. 13, the wasteful cycles 6 occur in the cycles T8 to T10 as in FIG. 8. When unpreferably the wasteful cycles occur to increase the process time, a control register value in the memory control circuit may make the switch not to execute the control method of FIG. 13.

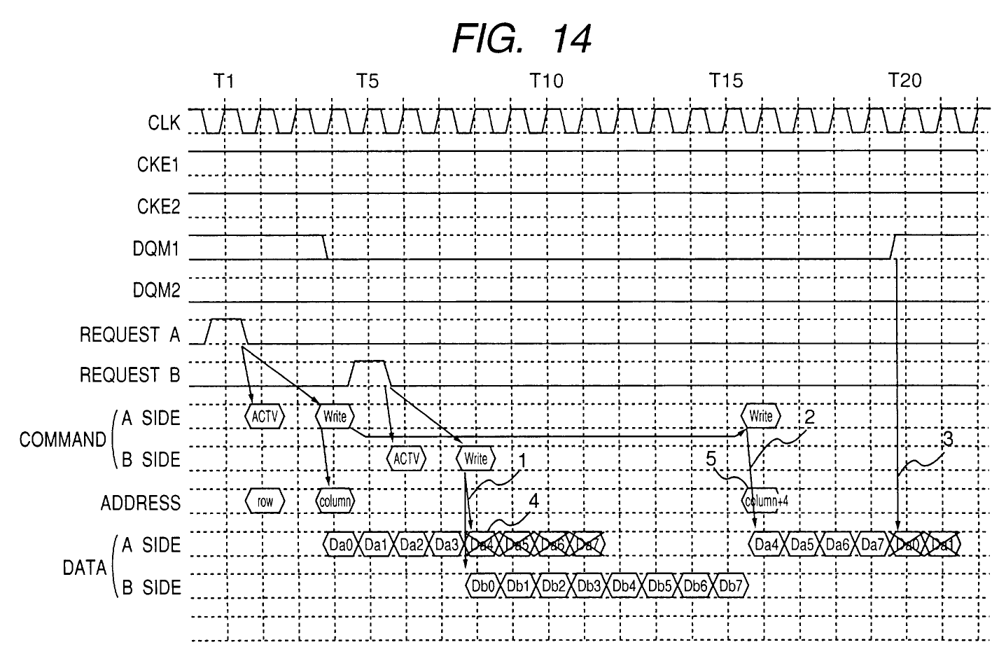

FIG. 14 is a diagram of assistance in explaining an operation of the same memory device, a different bank, a different ROW address, the preceding request being WRITE, and an interrupt request being WRITE.

The same operation as FIG. 9 is performed to the cycle T4. In the cycle T5, the interrupt WRITE request B from the processor B occurs to be transferred to the memory device M1. The data Da1 performing the write process of the preceding processor A side is also transferred to the memory device M1.

In the cycle T6, the active (ACTV) command corresponding to the WRITE request from the processor B in the cycle T5 is transferred to the memory device M1. The data Da2 performing the write process of the preceding processor A side is also transferred to the memory device M1.

In the cycle T8, the WRITE command for the process of the request B performs the cancel operation 1 canceling transfer to the memory device 1 after the write data Da4 of the preceding processor A. At the same time, the data Db0 to Db7 for the write process of the WRITE request B are transferred to the memory device 1. The cancel operation 1 is (1-1) of the above four control methods.

To sequentially execute the write process of the processor A, the WRITE command on the processor A side and the updated column address (column+4) are transferred to the memory device M1 in the cycle T16. The re-execution operation 2 for the burst write from the Da4 is performed. The re-execution operation 2 is (2-1) of the above two control methods.

In the cycle T20, to re-cancel transfer from the write data Da0 from the processor A, the data control signal DQM is at High level to execute the re-cancel operation 3. The re-cancel operation 3 is (3-2) of the above two control methods.

A control operation of the memory control circuit 26 is performed to be completed in 10 cycles after occurrence of the WRITE request B. The completion time limit of the request B can be satisfied. When performing the READ process of the request B after completing the WRITE process of the request A as in the prior art, the completion time limit of the request B can be satisfied in 16 cycles, which is slower than the control method of the present invention.

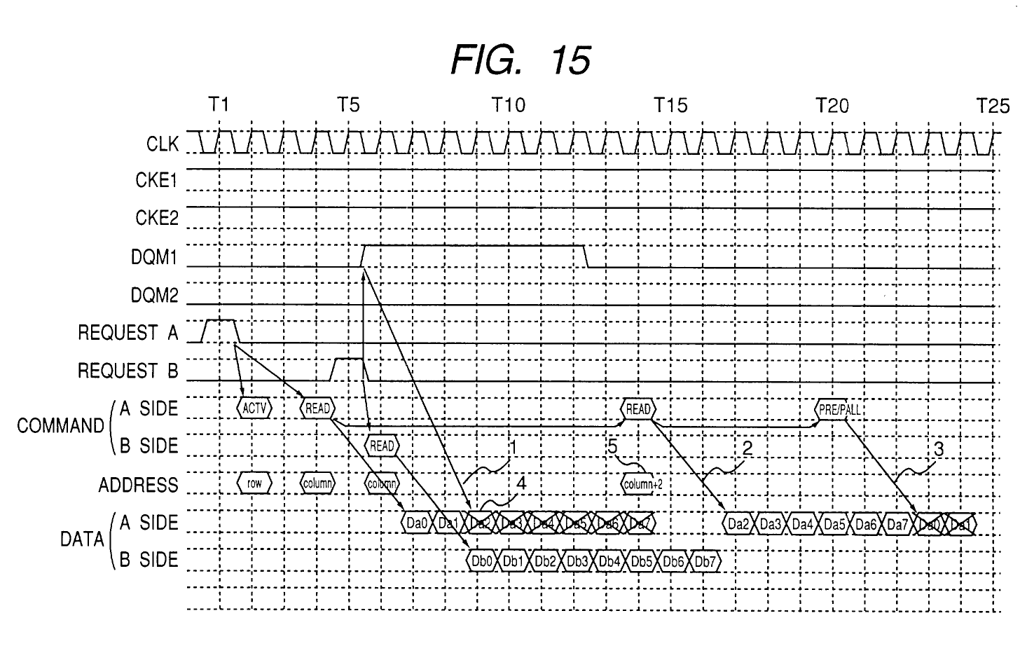

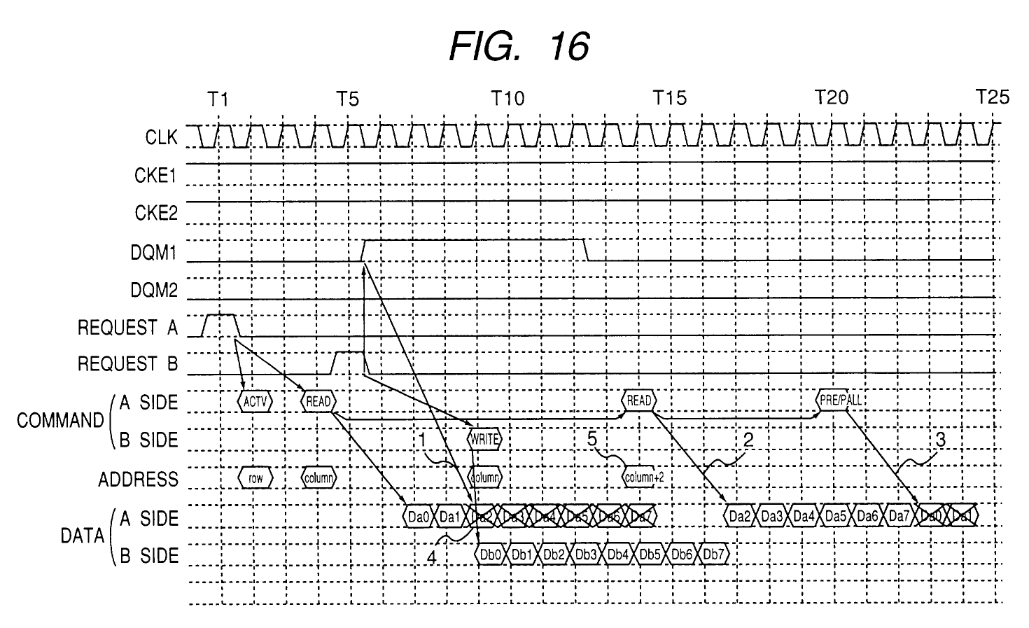

FIG. 15 is a diagram of assistance in explaining an operation of a different memory device, the same bank, the same ROW address, the preceding request being READ, and an interrupt request being READ. The preceding request is performed to the memory device M1. The interrupt request is performed to the memory device M2. This is the same in the following FIGS. 16 to 22.

In FIG. 15, in the periods of the cycles T6 to T12, the data control signal DQM1 is at High level.

The memory control circuit 26 receives the READ request signal (request A) from the processor A in the cycle T1 to transfer it to the memory device M1. The request signal from the processor A transfers to the memory device M1 the active (ACTV) command corresponding to the READ request from the processor A in the cycle T2 and transfers the row address to the memory device M1.

In the cycle T4, the READ command on the processor A side is transferred to the memory device M1 and the column address is transferred to the memory device M1.

In the cycle T5, the interrupt request from the processor B occurs and the READ request signal (request B) is transferred to the memory device M2. In the next cycle T6, the request signal transfers the READ command of the processor B and the column address to the memory device M2. The data control signal DQM1 is at High level.

From the cycle T7, the data Da0, Da1 stored into the row and column addresses of the memory device M1 specified by the request A are sequentially read to the processor A side.

In the cycle 9, the High level of the DQM1 in the cycle T6 performs the cancel operation 1 canceling the sequential data read process after the data Da2 of the request A. At the same time, the burst read from the data Db0 stored into the row and column addresses of the memory device M2 specified by the request B is started.

To sequentially execute the process of the request A from the cycle T17 completing read of the data Db7, the READ command on the processor A side and the updated column address (column+2) are transferred to the memory device M1 in the cycle 14. The re-execution operation 2 for the burst read from the data Da2 is performed. The re-execution operation 2 is (2-1) of the above two control methods.

In the cycle T20, to re-cancel transfer from the read data Da0 to the processor A side, the precharge command PRE/PALL on the A side is transferred to the memory device M1 (the re-cancel operation 3). The re-cancel operation 3 is (3-1) of the above two control methods.

A control operation of the memory control circuit 26 is performed to be completed in 11 cycles after occurrence of the READ request B. The completion time limit of the request B can be satisfied. When performing the READ process of the request B after completing the READ process of the request A as in the prior art, the completion time limit of the request B cannot be satisfied in 17 cycles.

FIG. 16 is a diagram of assistance in explaining an operation of a different memory device, the same bank, the same ROW address, the preceding request being READ, and an interrupt request being WRITE.

As in FIG. 15, in the periods of the cycles T6 to T12, the data control signal DQM1 is at High level. The same operation as FIG. 15 is performed to the cycle T4.

In the cycle T5, the interrupt request from the processor B occurs and the WRITE request signal (request B) is transferred to the memory device M2. In the cycle T9, the request signal transfers the WRITE command of the processor B, the column address and the write data Db0 to the memory device M2. In the process of the READ request A, the High level of the data control signal DQM1 in the cycle T6 cancels read from the data Da2 (the cancel operation 1).

The cancel operation 1 is (1-3) of the above four control methods.

To sequentially execute the process of the request A from the next cycle T17 completing read of the data Db7, the READ command on the processor A side and the updated column address (column+2) are transferred to the memory device MI in the cycle 14. The re-execution operation 2 for the burst read from the data Da2 is performed. The re-execution operation 2 is (2-1) of the above two control methods.

In the cycle T20, to re-cancel transfer after the read data Da0 to the processor A side, the precharge command PRE/PALL on the A side is transferred to the memory device M1 (the re-cancel operation 3). The re-cancel operation 3 is (3-1) of the above two control methods.

A control operation of the memory control circuit 26 is performed to be completed in 11 cycles after occurrence of the WRITE request B. The completion time limit of the request B can be satisfied. When performing the READ process of the request B after completing the READ process of the request A as in the prior art, the completion time limit of the request B cannot be satisfied in 17 cycles.

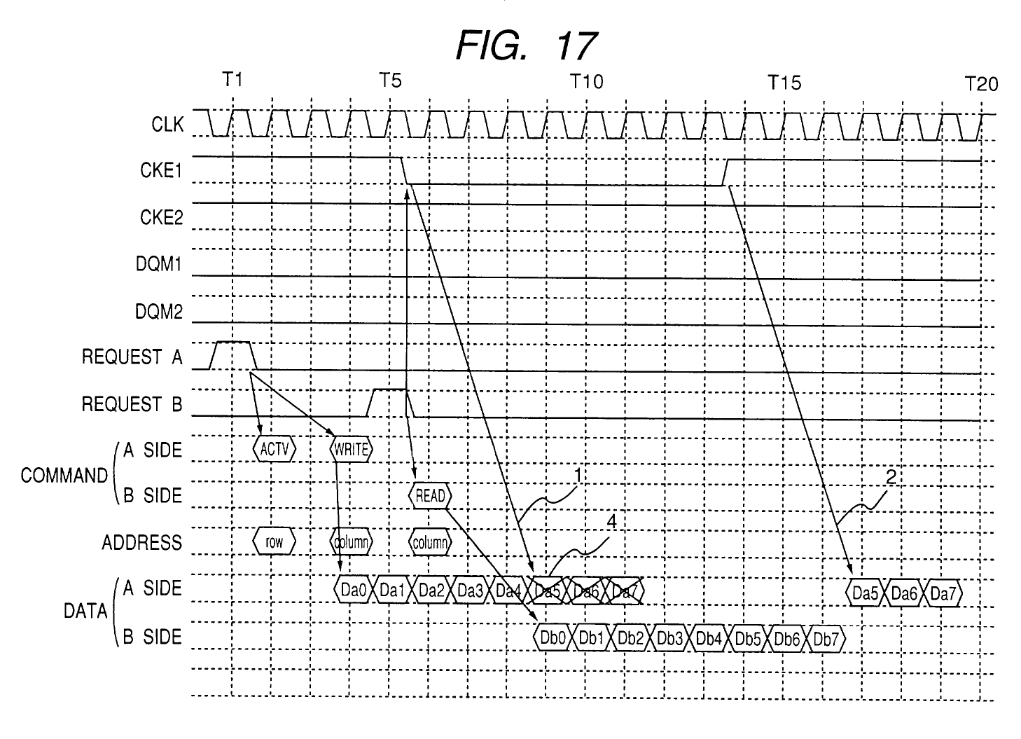

FIG. 17 is a diagram of assistance in explaining an operation of a different memory device, the same bank, the same ROW address, the preceding request being WRITE, and an interrupt request being READ.

The memory control circuit 26 receives the WRITE request signal (request A) from the processor A to transfer the request A to the memory device M1 in the cycle T1. The active (ACTV) command and the row address corresponding to the WRITE request from the processor A are transferred to the memory device M1 in the cycle T2.

In the cycle T4, the WRITE command on the processor A side and the column address are transferred to the memory device M1 and sequential transfer from the write data Da0 is started to be synchronized with the clock.

In the cycle T5, the interrupt request from the processor B occurs and the READ command on the processor B side and the column address are transferred to the memory device M2 in the cycle T6. The clock enable signal CKE1 is at the Low level. In the cycle T9, the READ command on the B side transfers the read data Db0 to Db7 from the memory device M2 to the processor B side.

The clock enable signal CKE1 in the cycles T6 to T13 is changed from the High level to the Low level. Fetching of the write data Da5 to Da7 on the processor A side is stopped and the write data are not transferred to the memory device 1 (the cancel operation 1). The cancel operation 1 is (1-4) of the above four control methods.

In the cycle T14 which is performing data read transfer from the memory device M2 by the READ request B, the clock enable CKE signal is changed from the Low level to the High level. In the cycle T17, transfer of the write data Da5 to Da7 to the memory device M1 which has been stopped temporarily is restarted (the re-execution operation 2). The re-execution operation 2 is (2-2) of the above two control methods. In FIG. 17, the re-execution operation is not re-execution by new burst write performed by transferring the updated column address. Excess data are not transferred. The re-cancel operation 3 is unnecessary.

A control operation of the memory control circuit 26 is performed to be completed in 11 cycles after occurrence of the READ request B. The completion time limit of the request B can be satisfied. When performing the READ process of the request B after completing the WRITE process of the request A as in the prior art, the completion time limit of the request B can be satisfied in 14 cycles, which is slower than the present invention.

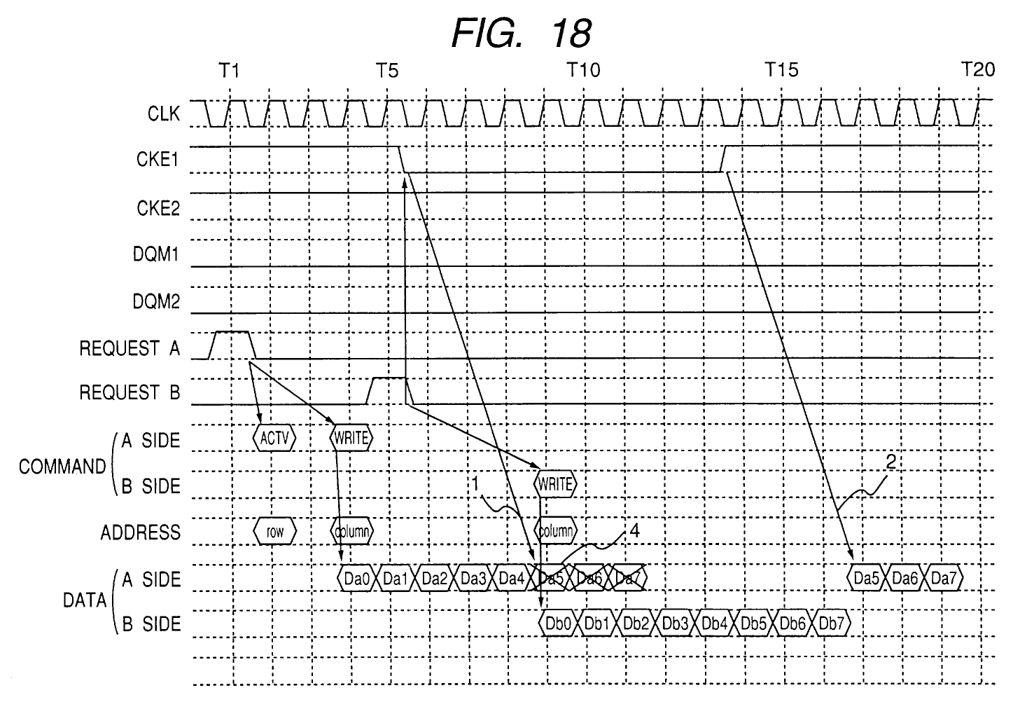

FIG. 18 is a diagram of assistance in explaining an operation of a different memory device, the same bank, the same ROW address, the preceding request being WRITE, and an interrupt request being WRITE.

The same operation as FIG. 17 is performed to the cycle T4. In the cycle T5, the interrupt request from the processor B occurs. In the cycle T9, the WRITE command on the processor B side and the column address are transferred to the memory device M2. In the cycle T9, the WRITE command on the processor B side starts transferring the write data Db0 to Db7 from the processor N side to the memory device M2.

In the cycle T6, the clock enable signal CKE1 is at the Low level. The clock enable signal is changed from the High level to the Low level. Fetching of the write data Da5 to Da7 on the processor A side is stopped and the write data are not transferred to the memory device M1 (the cancel operation 1). The cancel operation 1 is (1-4) of the above four control methods.

In the cycle T14 which is performing write data transfer to the memory device M2 by the WRITE request B, the clock enable CKE1 signal is changed from the Low level to the High level. In the cycle T17, transfer of the write data Da5 to Da7 to the memory device M1 which has been stopped temporarily is restarted (the re-execution operation 2). The re-execution operation 2 is (2-2) of the above two control methods. As in FIG. 17, the re-execution operation is not re-execution by new burst write performed by transferring the updated column address. Excess data are not transferred. The re-cancel operation 3 is unnecessary.

A control operation of the memory control circuit 26 is performed to be completed in 11 cycles after occurrence of the WRITE request B. The completion time limit of the request B can be satisfied. When performing the WRITE process of the request B after completing the WRITE process of the request A as in the prior art, the completion time limit of the request B can be satisfied in 14 cycles, which is slower than the present invention.

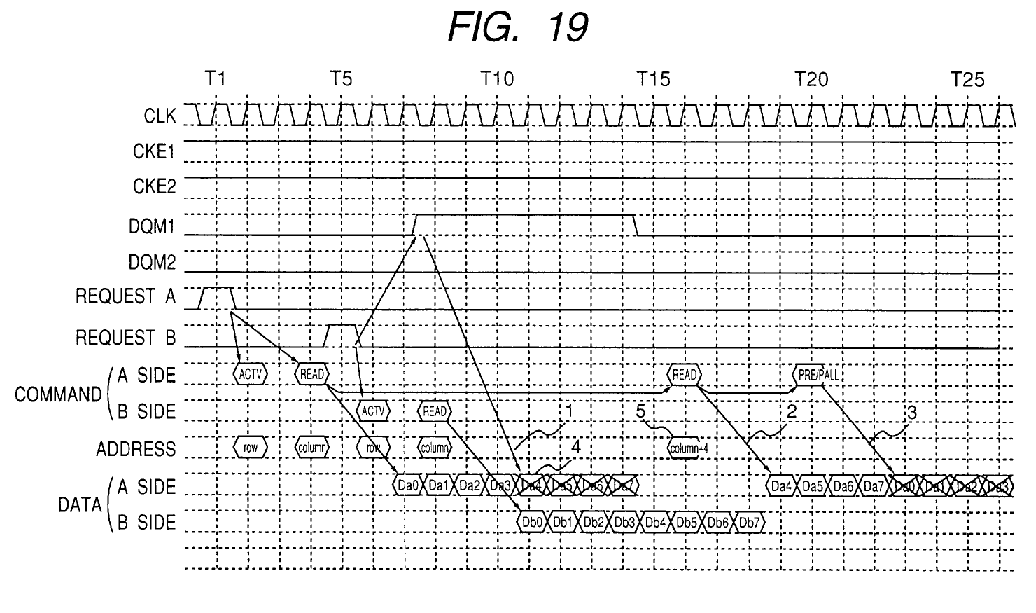

FIG. 19 is a diagram of assistance in explaining an operation of a different memory device, other than FIG. 15, the preceding request being READ, and an interrupt request being READ.

The same operation as FIG. 15is performed to the cycle T4. In the cycle T5, the interrupt request from the processor B occurs. In the cycle T6, the active (ACTV) command and the row address corresponding to the READ request on the processor B side are transferred to the memory device M2.

In the cycle T7, the READ request on the A side starts the burst read transfer of the data Da0 from the memory device M1.

In the cycle T8, the READ command on the B side corresponding to the READ request and the column address are transferred to the memory device M2. Also in the cycle T8, the interrupt READ request B in the cycle T5 allows the data control signal DQM1 to be at the High level. In the cycle T11, this cancels read from the data Da4 on the preceding A side (the cancel operation 1). The cancel operation 1 is (1-3) of the above four control methods.

In the cycle T11, the READ command on the B side in the cycle T8 starts read transfer of the data Db0 to Db7 of the memory device M2. In the cycle T16 of a period performing the read process by the READ request B, to restart the process of the READ request A, the READ command on the processor A side and the updated column address (column+4) are transferred to the memory device M1. In the next cycle T19 completing the process of the request B, the read process of the request A from the Da4 is started. In other words, the re-execution operation 2 is performed. The re-execution operation 2 is (2-1) of the above two control methods.

In the cycle T20, the precharge command (PRE/PALL) on the A side is transferred to the memory device M1 to —cancel transfer of the data Da0 to Da3 after the cycle T23 (the re-cancel operation). The re-cancel operation 3 is (3-1) of the above two control methods.

A control operation of the memory control circuit 26 is performed to be completed in 13 cycles after occurrence of the interrupt READ request. The completion time limit of the request B can be satisfied. In the prior art control method, the completion time limit of the request B cannot be satisfied in 17 cycles.

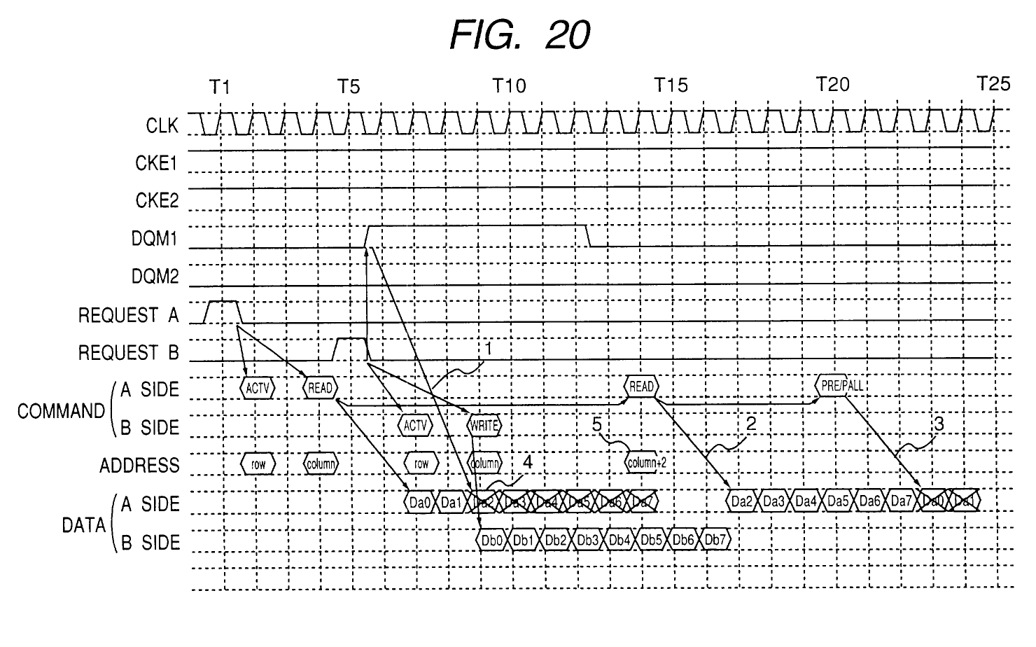

FIG. 20 is a diagram of assistance in explaining an operation of a different memory device, other than FIG. 16, the preceding request being READ, and an interrupt request being WRITE.

As in FIG. 16, in the cycles T6 to T12, the data control signal DQM1 is at the High level. The same operation as FIG. 16 is performed to the cycle T4.

In the cycle T5, the interrupt request from the processor B to the memory device M2 occurs and the WRITE request signal (request B) is transferred to the memory device M2. In the cycle T7, the active (ACTV) command and the row address corresponding to the WRITE request signal are transferred to the memory device M2. The data Da0 of the memory device M1 by the READ command on the processor A side is transferred to the A side.

In the cycle T9, the WRITE command on the processor B side, the column address and the write data Db0 are transferred to the memory device M2. In the process of the READ request A, the High level of the data control signal DQM1 in the cycle T6 cancels read after the data Da2 (the cancel operation 1). The cancel operation 1 is (1-3) of the above four control methods.

To sequentially execute the process of the READ request A from the next cycle T17 completing read of the data Db7, the READ command on the A side and the updated column address (column+2) are transferred to the memory device M1 in the cycle 14 (the re-execution operation 2). The re-execution operation 2 is (2-1) of the above two control methods.

In the cycle T20, to re-cancel transfer from the read data Da0 to the processor A side, the precharge command PRE/PALL on the A side is transferred to the memory device M1 (the re-cancel operation 3). The re-cancel operation 3 is (3-1) of the above two control methods.

A control operation of the memory control circuit 26 is performed to be completed in 11 cycles after occurrence of the WRITE request B. The completion time limit of the request B can be satisfied. When performing the READ process of the request B after completing the READ process of the request A as in the prior art, the completion time limit of the request B cannot be satisfied in 17 cycles.

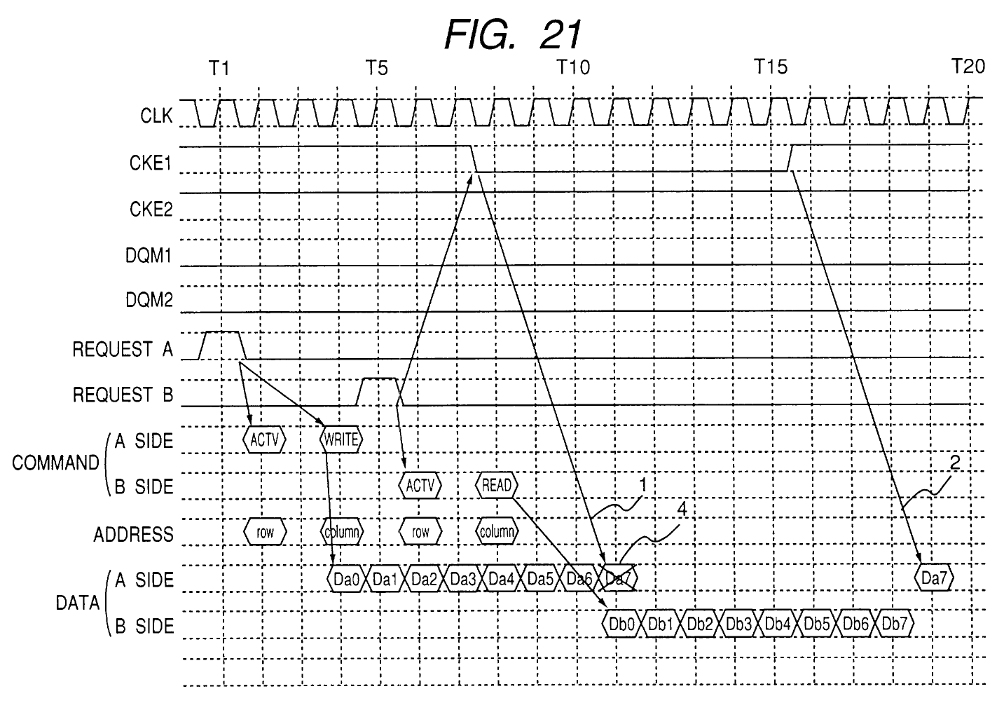

FIG. 21 is a diagram of assistance in explaining an operation of a different memory device, other than FIG. 17, the preceding request being WRITE, and an interrupt request being READ.

The same operation as FIG. 17 is performed to the cycle T4.

In the cycle T5, the interrupt READ request B from the processor B occurs. In the cycle T6, the active (ACTV) command and the row address corresponding to the READ request B are transferred to the memory device M2.

In the cycle T8, the READ command on the processor B side and the column address are transferred to the memory device M2. The clock enable signal CKE1 is at the Low level. In the cycle T11, the READ command on the B side transfers the read data Db0 to Db7 synchronized with the clock CLK signal from the memory device M2 to the processor B side.

The clock enable signal CKE1 in the cycle T8 is changed from the High level to the Low level. Fetching of the write data Da7 on the preceding processor A side in the cycle T11 is stopped and the write data is not transferred to the memory device M1 (the cancel operation 1). The cancel operation 1 is (1-4) of the above four control methods.

In the cycle T16 which is performing data read transfer from the memory device M2 to the processor B side by the READ request B, the clock enable CKE1 is changed from the Low level to the High level. In the cycle T19, transfer of the write data Da7 to the memory device M1 which has been stopped temporarily is restarted (the re-execution operation 2). The re-execution operation 2 is (2-2) of the above two control methods. As in FIG. 17, the re-execution operation is not re-execution by new burst write performed by transferring the updated column address. Excess data are not transferred. The re-cancel operation 3 is unnecessary.

A control operation by the memory control circuit 26 is performed to be completed in 13 cycles after occurrence of the READ request B. The completion time limit of the request B can be satisfied. When performing the READ process of the request B after completing the WRITE process of the preceding request A as in the prior art, the completion time is slower than the present invention.

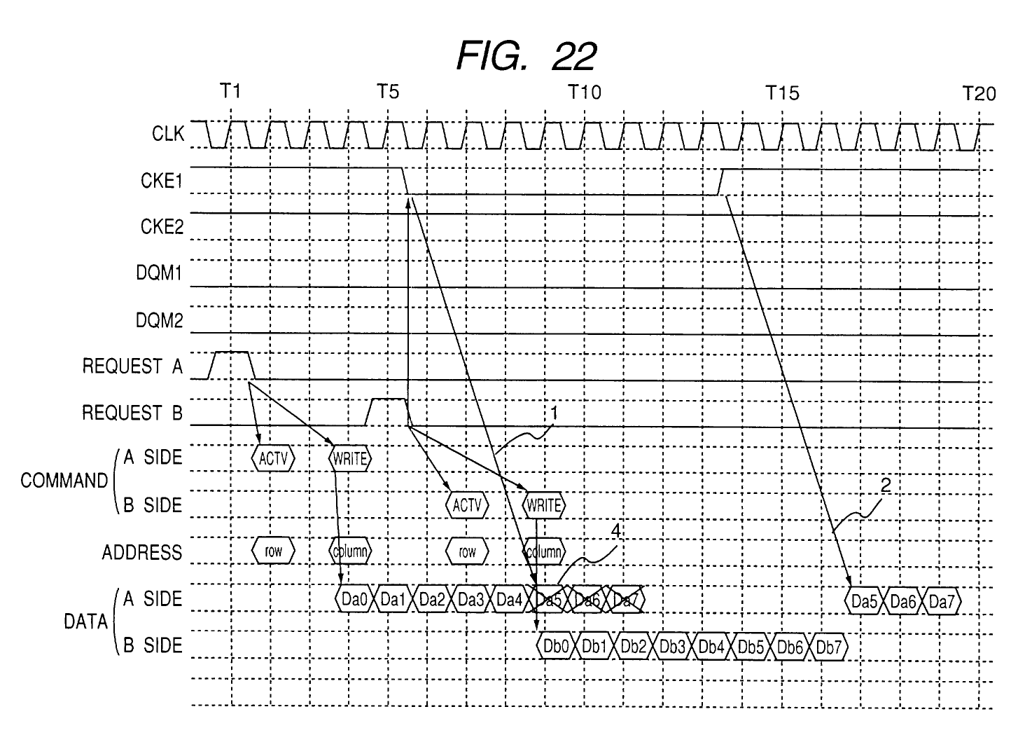

FIG. 22 is a diagram of assistance in explaining an operation of a different memory device, other than FIG. 18, the preceding request being WRITE, and an interrupt request being WRITE.

The same operation as FIG. 18 is performed to the cycle T4.

In the cycle T5, the interrupt WRITE request B from the processor B occurs. In the cycle T7, the active (ACTV) command and the row address corresponding to the WRITE request B are transferred to the memory device M2.

In the cycle T6, the clock enable signal CKE1 is at Low level. The clock enable signal is changed from the High level to the Low level. Fetching of the write data Da5 to Da7 to the memory M1 on the preceding processor A side after the cycle T9 is stopped and the write data are not transferred (the cancel operation 1). The cancel operation 1 is (1-4) of the above four control methods.

In the cycle T14 which is performing write data transfer to the memory device M2 by the WRITE request B, the clock enable CKE1 signal is changed from the Low level to the High level. In the cycle T17, transfer of the write data Da5 to Da7 on the preceding A side to the memory device M1 which has been stopped temporarily is restarted (the re-execution operation 2). The re-execution operation 2 is (2-2) of the above two control methods. As in FIG. 18, the re-execution operation is not re-execution by new burst write performed by transferring the updated column address. Excess data are not transferred. The re-cancel operation 3 is unnecessary.

A control operation of the memory control circuit 26 is performed to be completed in 11 cycles after occurrence of the WRITE request B. The completion time limit of the request B can be satisfied. When performing the WRITE process of the request B after completing the WRITE process of the request A as in the prior art, the completion time limit of the request B can be satisfied in 14 cycles, which is slower than the present invention.

<Embodiment 2>

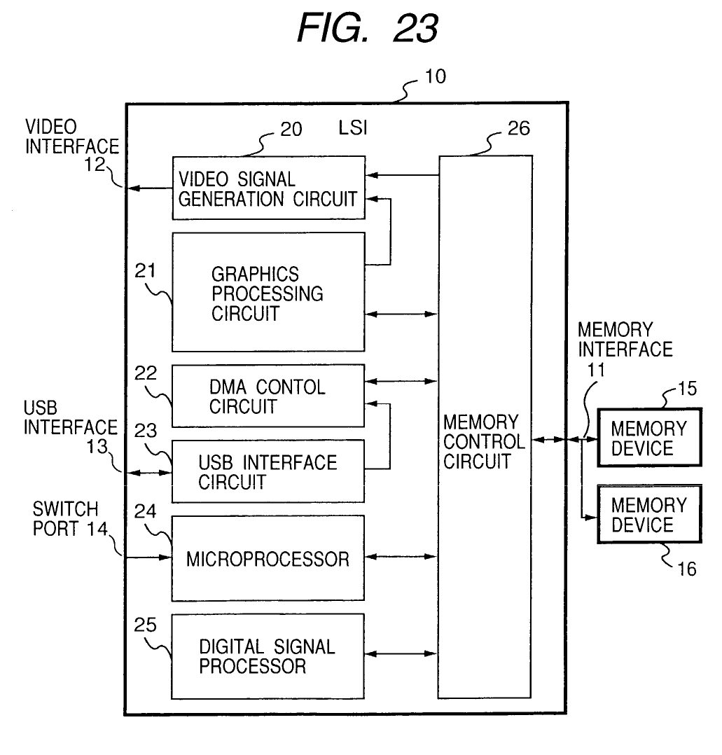

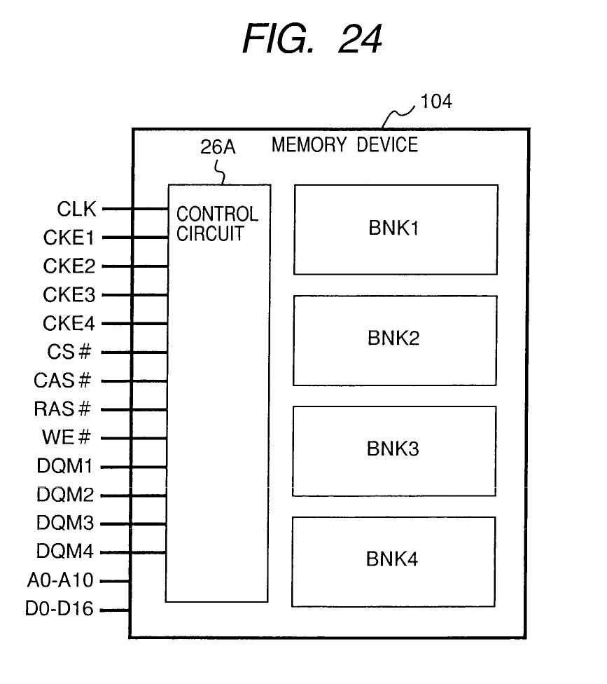

In Embodiment 1, the case that the standard synchronous DRAM is targeted is described. In this embodiment, using FIGS. 24 to 26, three configurations of the synchronous DRAM applying the memory control circuit according to the present invention which is adapted to the interrupt access process described in Embodiment 1, will be described.

The first one is a memory device (synchronous DRAM) having a clock enable terminal and a data mask terminal for each bank. In an example of a memory device 104 shown in FIG. 24, there is provided a memory control circuit 26A having clock enable terminals CKE1 to 4 and data mask terminals DQM1 to 4 for four banks BNK1 to 4.

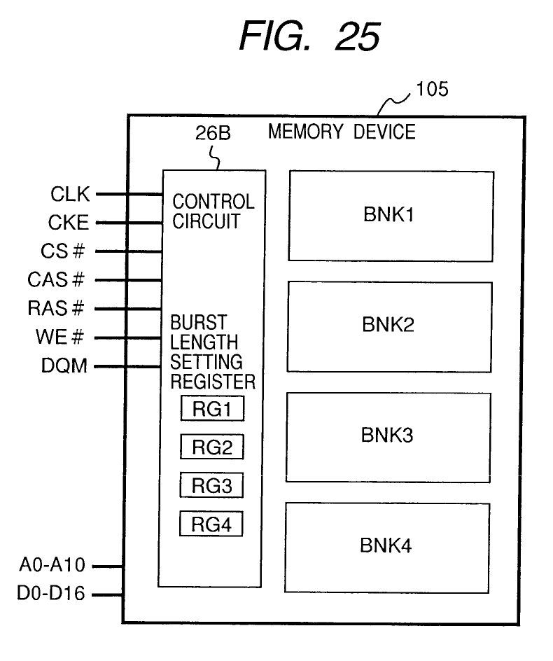

The second one is a memory device (synchronous DRAM) 105 having a register setting a burst length for each bank. In an example shown in FIG. 25, there is provided a memory control circuit 26B having four burst length setting registers RG1, RG2, RG3 and RG4.

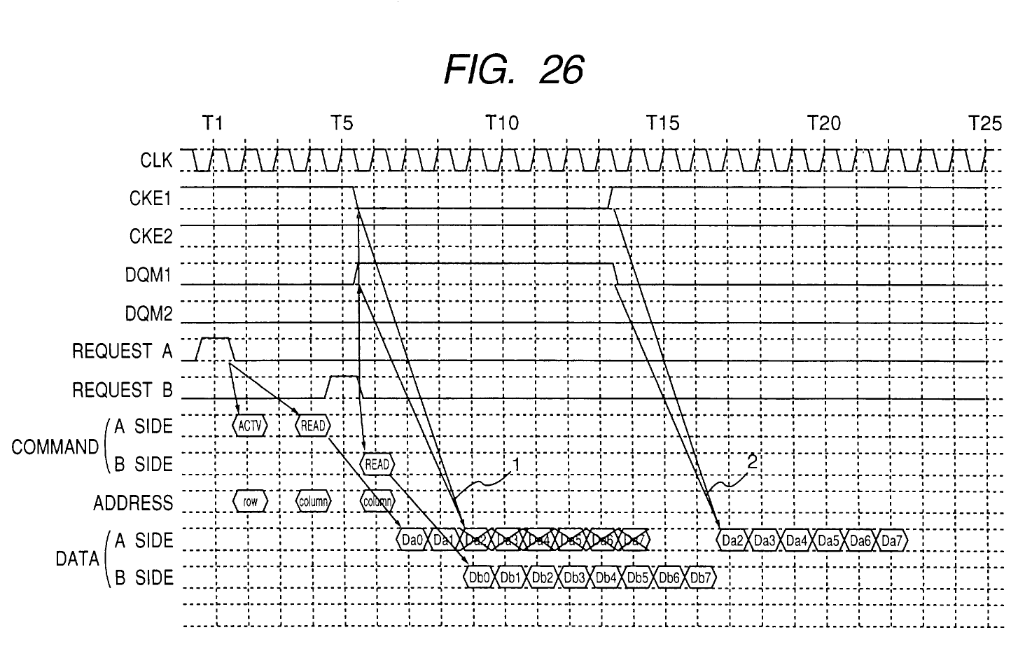

The third one is a memory device (synchronous DRAM) having a memory control circuit allowing an output to be in a high impedance state when asserting the data mask DQM during a memory access to negate the clock enable CKE. FIG. 26 is a time chart showing an operation under the same operation condition as FIG. 15 of Embodiment 1 when using such memory device, that is, an operation in which a different memory device, the same bank, the same ROW address, the preceding request being READ, and the interrupt request is READ.

The same operation as FIG. 15 is performed to the cycle T4. In the cycle T5, an interrupt request from the processor B occurs to transfer the READ request signal (request B) to the memory device M2. In the next cycle T6, the request signal transfers the READ command of the processor B and the column address to the memory device M2. The data control signal DQM1 is at the High level and the clock enable CKE1 is changed from the High level to the Low level.

The data Da0, Da1 stored into the row and column addresses of the memory device M1 specified by the request A from the cycle T7 are sequentially read to the processor A side.

The data Da0, Da1 stored into the row and column addresses of the memory device M1 specified by the request A from the cycle T7 are sequentially read to the processor A side.

In the cycle T9, the High level f the data control signal DQM1 and the Low level of the clock enable CKE1 in the cycle T6 perform the cancel operation 1 stopping the sequential data read process from the data Da2 of the request A. At the same time, the burst read from the data Db0 stored into the row and column addresses of the memory device M2 specified by the request B is started.

The Low level of the DQM1 and the High level of the clock enable CKE1 in the cycle T14 restart transfer after the data Da2 of the memory device M1 by the READ request A which has stopped temporarily from the next cycle T17 completing read of the data Db7 (re-execution operation 2). The re-cancel operation 3 is unnecessary. The completion time limit of the request B can be satisfied in 11 cycles after occurrence of the interrupt request B of the processor B.

The memory device is used to realize a memory control circuit performing the same operation in the number of issued commands fewer than that of the memory control circuit 26 shown in FIGS. 5 to 22.

In the embodiment of the memory control circuit, means for deciding priority of a plurality of requests will be described.

A first means for deciding priority decides priority for each processor. In the examples shown in FIGS. 5 to 22, the request from the processor B is preceded. This is decided when designing the circuit.

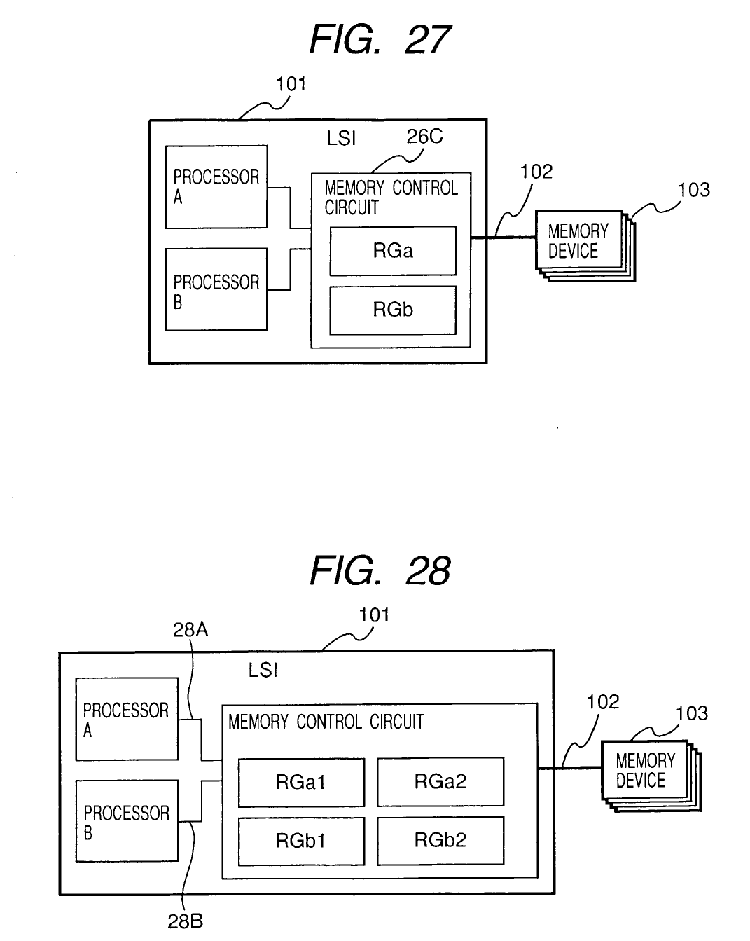

A second means uses a memory control circuit 26C having registers RGa, RGb setting priority for each processor as in FIG. 27. This configuration can change the priority for each processor. For example, when the processor A is a microprocessor and an operating system (OS) is operated on the microprocessor, the priority setting registers RGa, RGb are rewritten for each task switch of the OS to change the priority for each task.

A third means is provided with a plurality of priority setting registers for each processor in a memory control circuit 26D as in FIG. 28. At this time, the plurality of priority setting registers RGa1, RGa2, RGb1 and RGb2 are switched by a signal value in a signal 28A connecting the processor A and the memory control circuit 26D and a signal 28B connecting the processor B and the memory control circuit 26D.

For example, depending on whether the request from the processor is the READ request or the WRITE request, the priority of the priority setting registers may be decided. Otherwise, the priority of the priority setting registers may be decided an address value of the request from the processor. Otherwise, the priority of the priority setting registers may be decided by a mode signal value outputted from the processor. Here, the mode signal corresponds to discrimination of the user mode and the privilege mode of a CPU.

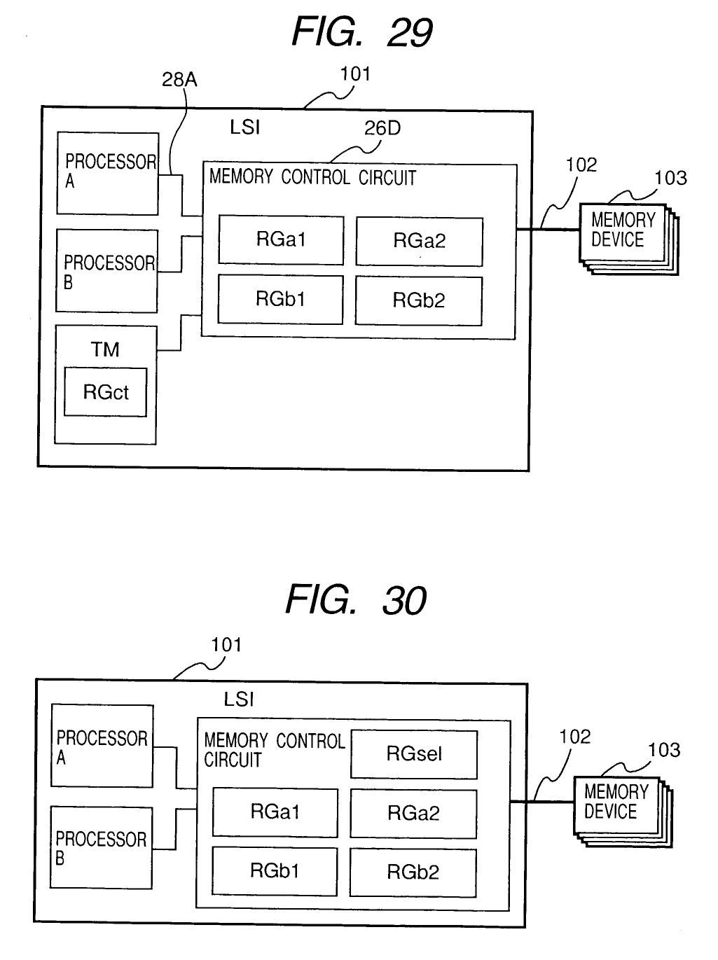

In FIG. 29, a timer TM is used as a method for switching the priority setting registers. A signal may be sent to the memory control circuit 26D at time intervals set to a counter value register RGct in the timer TM to switch the priority setting registers RGa1, RGa2, RGb1 and RGb2.

FIG. 30 is a configuration example when the priority setting can be switched by a value of a priority setting method selection register RGsel provided in a memory control circuit 26E.

In the case of contention of three or more access processes, a value of the priority setting method selection register RGsel may set whether multi-interrupt interrupting the next request during the interrupt request process is performed or not.

Using the present invention, in an integrated circuit incorporating a plurality of circuits performing a memory access and a memory control circuit processing memory access requests from all the circuits performing a memory access, in the case of contention of memory accesses of the circuits performing a memory access, the memory access which must be completed within a fixed time can be processed precedably. It is possible to solve the problem that the operation quality of the system using the integrated circuit is deteriorated because the completion time limit of the memory access cannot be followed.

What is claimed is:

1. A method for controlling a memory control circuit which can process a plurality of memory access requests, wherein a precedably processed low-priority memory access process is interrupted, a later high-priority memory access process is performed, and said interrupt low-priority memory access process is re-executed.

2. The memory control method according to claim 1, wherein as a control method for interrupting the preceding memory access, there is used any one of:
a method for giving a command of the next memory access;
a method for giving a precharge command;
a method for asserting a data mask signal; and
a method for deasserting a clock enable signal.

3. The memory control method according to claim 2, wherein as a method for restarting an interrupt memory access, there is used any one of:
a method for giving a command for the Interrupt memory access again; and
a method for asserting a clock enable signal.

4. The memory control method according to claim 3, wherein depending on whether the immediately preceding memory access in a memory device accessed by a later high-priority memory access is an access to the same bank or an access to the same ROW address, said interrupt method and said restarting method are switched.

5. The memory control method according to claim 4, wherein as a method for restarting an interrupt memory access, when giving a command for the interrupt memory access again,
the next address of a read address or a written address before interruption is given to restart the memory access.

6. The memory control method according to claim 5, wherein when the restarted memory access process is a redundant memory access process to the read or written address, a precharge command is given or a data mask signal is asserted to inhibit said redundant memory access process.

7. A memory control circuit which can process a plurality of memory access requests, comprising:
a function interrupting the precedably processed low-priority memory access process;
a function performing a later high-priority memory access process; and
a function re-executing said interrupt low-priority memory access process.

8. The memory control circuit according to claim 7, wherein said memory control circuit is a memory control circuit controlling an access process of a synchronous DRAM or a double data rate synchronous DRAM.

9. An integrated circuit device connected via a memory interface to at least one external memory device, comprising:
at least two processing circuits performing an access request to said memory device; and
a memory control circuit which can process a plurality of memory access requests between said processing circuits and said memory device,
the memory control circuit comprising:
means for interrupting the precedably processed low-priority memory access of said one processing circuit;
means for performing a later high-priority memory access process of said other processing circuit; and
means for re-executing said interrupt low-priority memory access request.

10. The integrated circuit device according to claim 9, wherein said memory control circuit incorporates registers setting priority for each of the processing circuits as said plurality of memory access request sources.
